(19) United States
(12) Patent Application Publication
(10) Pub. No.: US 2025/0139792 A1
(43) Pub. Date: May 1, 2025

(54) METHOD FOR TRAINING MOTION COMPLETION MODEL, MOTION COMPLETION METHOD AND APPARATUS, DEVICE, STORAGE MEDIUM, AND COMPUTER PROGRAM PRODUCT

(71) Applicant: Tencent Technology (Shenzhen) Company Limited, Shenzhen (CN)

(72) Inventors: Yu CAO, Shenzhen (CN); Zhisheng WANG, Shenzhen (CN)

(21) Appl. No.: 19/005,447

(22) Filed: Dec. 30, 2024

Related U.S. Application Data
(63) Continuation of application No. PCT/CN2023/130726, filed on Nov. 9, 2023.

(30) Foreign Application Priority Data
Jan. 6, 2023 (CN) 202310018352.9

(51) Int. Cl. G06T 7/246

(52) U.S. Cl. CPC G06T 7/246; G06T 2207/20044; G06T 2207/20081

(57) ABSTRACT

This application provides a method for training a motion completion model performed by an electronic device. The method includes: obtaining a motion sequence sample, the motion sequence sample including at least three consecutive motion frames; determining at least one first motion sub-sequence sample from the motion sequence sample, the first motion sub-sequence sample having two second motion sub-sequence samples adjacent thereto; performing masking processing on the at least one first motion sub-sequence sample, to obtain a target motion sequence sample; performing motion completion processing on the target motion sequence sample through a motion completion model, to obtain a completing motion sequence; and updating a model parameter of the motion completion model based on a difference between the completing motion sequence and the at least one first motion sub-sequence sample, to obtain a trained motion completion model.

### CROSS-REFERENCE TO RELATED APPLICATIONS

This application is a continuation application of PCT Patent Application No. PCT/CN2023/130726, entitled “METHOD FOR TRAINING MOTION COMPLETION MODEL, MOTION COMPLETION METHOD AND APPARATUS, DEVICE, STORAGE MEDIUM, AND COMPUTER PROGRAM PRODUCT” filed on Nov. 9, 2023, which is based on and claims priority to Chinese Patent Application No. 202310018352.9, entitled “METHOD FOR TRAINING MOTION COMPLETION MODEL, MOTION COMPLETION METHOD AND APPARATUS, DEVICE, STORAGE MEDIUM, AND COMPUTER PROGRAM PRODUCT” filed on Jan. 6, 2023, both of which are incorporated herein by reference in their entirety.

### FIELD OF THE TECHNOLOGY

This application relates to the field of artificial intelligence technologies, and in particular, to a method for training a motion completion model, a motion completion method and apparatus, a device, a storage medium, and a computer program product.

### BACKGROUND OF THE DISCLOSURE

When a motion sequence (or referred to as a motion frame segment) of an object (for example, a digital human or a virtual human) is played, motion frames of two motion sequences are often inconsecutive, resulting in playing problems such as discontinuous and unsmooth motion frames. Therefore, motion completion needs to be performed between two motion sequences. In the related art, motion completion is implemented through linear interpolation. To be specific, computation is performed based on an end motion frame of a current motion sequence, a start motion frame of a motion sequence next to the current motion sequence, and a given quantity of motion frames to be inserted, to obtain motion frames to be inserted, to achieve motion completion. However, motion frames obtained by motion completion based on linear interpolation are not precise, and the efficiency of motion completion based on linear interpolation is not high.

### SUMMARY

Embodiments of this application provide a method for training a motion completion model, a motion completion method and apparatus, a device, a storage medium, and a computer program product, which can improve precision and efficiency of motion completion processing.

The technical solutions of the embodiments of this application are implemented in the following manner.

An embodiment of this application provides a method for training a motion completion model. The method is performed by an electronic device, and includes:
determining at least one first motion sub-sequence sample from a motion sequence sample, the first motion sub-sequence sample having two second motion sub-sequence samples adjacent thereto, and the first motion sub-sequence sample and the two second motion sub-sequence samples each comprising at least one motion frame from the motion sequence sample;
performing masking processing on the at least one first motion sub-sequence sample, to obtain a target motion sequence sample;
performing motion completion processing on the target motion sequence sample through the motion completion model, to obtain a completing motion sequence; and
updating a model parameter of the motion completion model based on a difference between the completing motion sequence and the at least one first motion sub-sequence sample, to obtain a trained motion completion model.

The trained motion completion model is configured to perform motion completion processing on at least two motion sequences, to obtain a target motion sequence, motion frames of the at least two motion sequences are inconsecutive, and the target motion sequence is configured to cause the motion frames of the at least two motion sequences to be consecutive.

An embodiment of this application provides a motion completion method. The method is performed by an electronic device, and includes:
obtaining at least two motion sequences on which motion completion is to be performed, motion frames of the at least two motion sequences being inconsecutive;
performing motion completion processing on the at least two motion sequences by invoking a motion completion model, to obtain a target motion sequence, the target motion sequence being configured to cause the motion frames of the at least two motion sequences to be consecutive; and
combining the target motion sequence and the at least two motion sequences, to obtain a target completed motion sequence of the at least two motion sequences.

The motion completion model is obtained through training based on the method for training a motion completion model provided in the embodiments of this application.

An embodiment of this application further provides an electronic device, including:
a memory, configured to store computer-executable instructions; and
a processor, configured to implement, when executing the computer-executable instructions stored in the memory, the method provided in the embodiments of this application.

An embodiment of this application further provides a computer-readable storage medium, having computer-executable instructions or a computer program stored therein, the computer-executable instructions or the computer program, when executed by a processor, implementing the method provided in the embodiments of this application.

The embodiments of this application have the following beneficial effects:

According to the embodiments of this application, at least one first motion sub-sequence sample is first determined from a motion sequence sample including at least three consecutive motion frames. The first motion sub-sequence sample has two second motion sub-sequence samples adjacent thereto Masking processing is performed on the at least one first motion sub-sequence sample, to obtain a target motion sequence sample. Motion completion processing is then performed on the target motion sequence sample through a motion completion model, to obtain a completing motion sequence, so that a model parameter of the motion completion model is updated based on a difference between the completing motion sequence and the at least one first motion sub-sequence sample that is masked, to train the motion completion model. In this way, a trained motion completion model is obtained.

Through the trained motion completion model, motion completion processing can be performed on at least two motion sequences in which motion frames of the motion sequences are inconsecutive, to obtain a target motion sequence. The target motion sequence enables the motion frames of the at least two motion sequences to be consecutive. In this way, when motion completion processing is performed on a motion sequence of an object (for example, a digital human or a virtual human) through the trained motion completion model, precision of the motion completion processing can be improved, and motion completion processing of two or more motion sequences in which motion frames are inconsecutive between the motion sequences can be implemented, thereby improving efficiency of the motion completion processing.

### BRIEF DESCRIPTION OF THE DRAWINGS

FIG. 1 is a schematic architecture diagram of a system 100 for training a motion completion model according to an embodiment of this application.

FIG. 2 is a schematic structural diagram of an electronic device 500 implementing a method for training a motion completion model according to an embodiment of this application.

FIG. 3 is a schematic flowchart of a method for training a motion completion model according to an embodiment of this application.

FIG. 4 is a schematic diagram of motion frames included in a motion sequence sample according to an embodiment of this application.

FIG. 5 is a schematic diagram of a first motion sub-sequence sample and a second motion sub-sequence sample according to an embodiment of this application.

FIG. 6 is a schematic diagram of an object skeleton model according to an embodiment of this application.

FIG. 7 is a schematic structural diagram of a motion completion model according to an embodiment of this application.

FIG. 8 is a schematic diagram of training of a motion completion model according to an embodiment of this application.

FIG. 9A is a schematic diagram of motion completion processing according to an embodiment of this application.

FIG. 9B is a schematic flowchart of a motion completion method according to an embodiment of this application.

FIG. 10 is a schematic diagram of motion completion processing according to an embodiment of this application.

FIG. 11 is a schematic flowchart of a method for training a motion completion model according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following descriptions, the term “some embodiments” describes subsets of all possible embodiments, but “some embodiments” may be the same subset or different subsets of all the possible embodiments, and can be combined with each other in the case of no conflict.

In the following descriptions, the term “first/second/third” is merely intended to distinguish between similar objects and does not indicate a specific order of the objects. “First/second/third” may be interchanged with a specific order or sequence if allowed, so that the embodiments of this application described herein can be implemented in an order other than that illustrated or described herein.

Unless otherwise defined, meanings of all technical and scientific terms used in this specification are the same as those usually understood by a person skilled in the art to which this application belongs. The terms used in the specification are merely intended to describe objectives of the embodiments of this application, but are not intended to limit this application.

Before the embodiments of this application are described in further detail, descriptions are made on the terms in the embodiments of this application, and the terms in the embodiments of this application are applicable to the following explanations.

(1) Client: A client is an application running in a terminal and configured to provide various services, for example, a client supporting motion completion processing.

(2) In response to: In response to is configured for representing a condition or a state on which a performed operation depends, and when the condition or the state on which the performed operation depends is met, one or more operations may be performed in real time or may have a set delay; and unless otherwise specified, there is no limitation on a sequence in which a plurality of operations are performed.

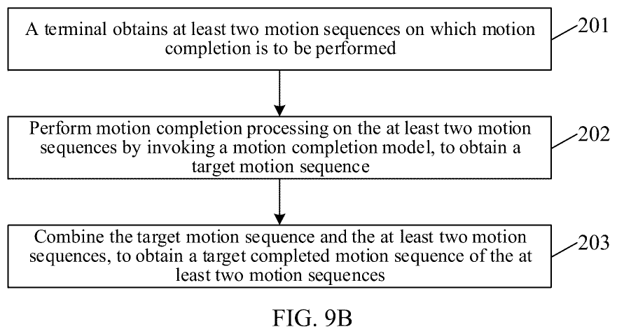

(3) Motion infilling/Motion completion: At least two inconsecutive motion sequences (including motion frame parameters of motion frames in the motion sequence) are provided, and the motion completion model can output a completing motion sequence based on the at least two motion sequences, to complete a motion sequence between the at least two motion sequences, so that the two motion sequences can be smoothly connected. As shown in FIG. 9A, two motion sequences are included: a motion sequence 1 and a motion sequence 2. In (1) in FIG. 9A, motion frames of the motion sequence 1 and the motion sequence 2 are inconsecutive. To be specific, a significant sense of incontinuity exists between the last motion frame in the motion sequence 1 and the first motion frame in the motion sequence 2. In other words, a motion sequence is missing between the motion sequence 1 and the motion sequence 2. In the embodiments of this application, motion completion processing may be performed on “the motion sequence 1 and the motion sequence 2” through the motion completion model, to obtain a motion sequence 3. As shown in (2) in FIG. 9A, the motion sequence 3 is placed between the motion sequence 1 and the motion sequence 2, and the motion sequence 3 becomes a transition between the motion sequence 1 and the motion sequence 2, to cause motion frames of the motion sequence 1 and the motion sequence 2 to be consecutive, so that transition from the last motion frame in the motion sequence 1 to the first motion frame in the motion sequence 2 is smoother, and the sense of incontinuity is weakened. In other words, “the motion sequence 1—the motion sequence 3—the motion sequence 2” forms a motion sequence in which motion frames are consecutive, achieving motion completion.

(4) Digital human: A digital human is a digital person image that is close to a human image and that is created by using a digital technology. An identity of the digital human may be set based on a person in the real world, and an appearance may be completely consistent with the person. A category of the digital human includes a virtual human, and a category of the virtual human includes a virtual digital human.

The virtual human is a virtual person with a digital appearance, and is obtained through virtual production by using a computer graphics technology. The virtual human depends on a display device for existence, and possesses an appearance of a human (for example, the appearance is like a human), an action of a human (for example, the virtual human can speak or can hold hands), and an idea of a human (for example, the virtual human can speak with a human). For the digital human, a point is that a character exists in the digital world. For the virtual digital human, a point is a virtual identity and digital production characteristics. The virtual digital human is a comprehensive product that exists in a non-physical world, is created and used by computer means such as computer graphics, graphics rendering, motion frame capture, deep learning, and speech synthesis, and has a plurality of human features (an appearance feature, a human performance capability, a human interaction capability, and the like).

Artificial intelligence (AI) is a comprehensive technology of computer science, which is to study design principles and implementation methods of various intelligent machines, to enable machines to have the functions of perception, reasoning, and decision-making. The artificial intelligence technology is a comprehensive discipline and relates to a wide range of fields, for example, several major directions such as a natural language processing technology and machine learning/deep learning. With the development of technologies, the artificial intelligence technology will be applied to more fields and play increasingly important values. Based on this, the embodiments of this application provide a method for training a motion completion model, a motion completion method and apparatus, an electronic device, a computer-readable storage medium, and a computer program product, which relate to artificial intelligence technologies, and can improve precision and efficiency of motion completion processing. Descriptions are separately provided below.

Data collection and processing in this application need to be strictly in accordance with the requirements of relevant laws and regulations when applied in practice, and the informed consent or separate consent of the personal information subject needs to be obtained. Subsequent data use and processing need to be carried out within the scope of authorization of laws and regulations and the personal information subject.

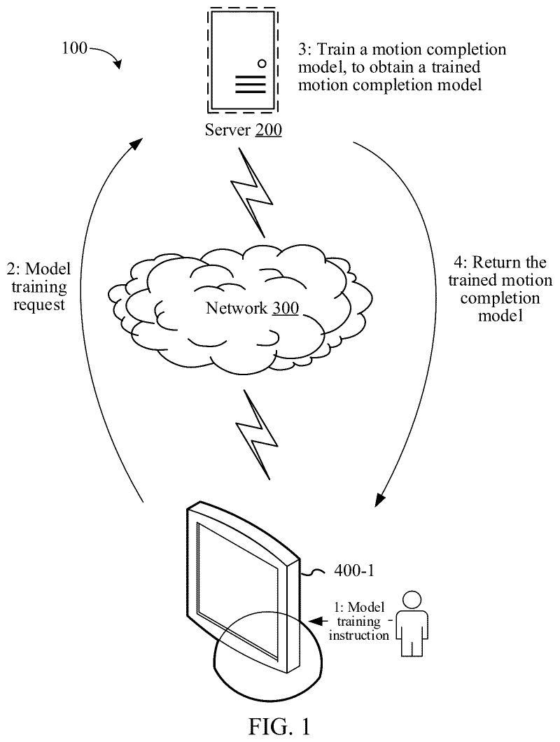

The following describes a system for training a motion completion model provided in the embodiments of this application. FIG. 1 is a schematic architecture diagram of a system 100 for training a motion completion model according to an embodiment of this application. To support an exemplary application, a terminal (a terminal 400-1 is shown as an example) is connected to a server 200 through a network 300. The network 300 may be a wide area network or a local area network, or a combination thereof, and data transmission is implemented by using a wireless link or a wired link.

The terminal (for example, 400-1) is configured to transmit a model training request for the motion completion model to the server 200 in response to a model training instruction for the motion completion model. The server 200 is configured to: receive the model training request transmitted by the terminal; obtain a motion sequence sample in response to the model training request, where the motion sequence sample includes at least three consecutive motion frames; determine at least one first motion sub-sequence sample from the motion sequence sample, where the first motion sub-sequence sample has two second motion sub-sequence samples adjacent thereto, and the first motion sub-sequence sample and the second motion sub-sequence samples each include at least one of the motion frames; perform masking processing on the at least one first motion sub-sequence sample in the motion sequence sample, to obtain a target motion sequence sample; perform motion completion processing on the target motion sequence sample through the motion completion model, to obtain a completing motion sequence; and update a model parameter of the motion completion model based on a difference between the completing motion sequence and the at least one motion sub-sequence sample, to train the motion completion model. In this way, a trained motion completion model is obtained.

In some embodiments, after obtaining the trained motion completion model, the server 200 may actively transmit the trained motion completion model to the terminal (for example, 400-1), for use by the terminal when performing motion completion processing. Certainly, the terminal may alternatively actively obtain the motion completion model from the server 200 when performing motion completion processing. In this case, the server 200 transmits the motion completion model to the terminal when the terminal actively obtains the motion completion model.

For example, a client supporting motion completion processing may be configured in the terminal (for example, 400-1). When motion completion processing is performed, a user may trigger a motion completion instruction on the terminal (for example, 400-1) through the client. The terminal obtains a motion completion model from the server 200 in response to the motion completion instruction. At least two motion sequences on which motion completion is to be performed are obtained simultaneously, where motion frames of the at least two motion sequences are inconsecutive. Motion completion processing is performed on the at least two motion sequences through the motion completion model, to obtain a target motion sequence, where the target motion sequence is configured to cause the motion frames of the at least two motion sequences to be consecutive. For example, when two motion sequences are provided, motion frames of the two motion sequences are inconsecutive. When the target motion sequence is obtained through the motion completion model, the target motion sequence may be placed between the two motion sequences, so that the target motion sequence becomes a transition between the two motion sequences, to cause the motion frames of the two motion sequences to be consecutive.

In some embodiments, the method for training a motion completion model provided in the embodiments of this application may be implemented by various electronic devices, for example, may be separately implemented by a terminal, or may be separately implemented by a server, or may be collaboratively implemented by a terminal and a server. The method for training a motion completion model provided in the embodiments of this application may be applied to various scenarios, including, but not limited to, a cloud technology, artificial intelligence, intelligent transportation, assisted driving, games, videos, and the like.

In some embodiments, the electronic device implementing the method for training a motion completion model provided in the embodiments of this application may be various types of terminals or servers. The server (for example, the server 200) may be an independent physical server, or may be a server cluster including a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal (for example, the terminal 400-1) may be a smartphone, a tablet computer, a notebook computer, a desktop computer, a smart voice interaction device (for example, a smart speaker), a smart appliance (for example, a smart television), a smartwatch, an in-vehicle terminal, a wearable device, a virtual reality (VR) device, or the like, but is not limited thereto. The terminal and the server may be directly or indirectly connected in a wired or wireless communication manner. This is not limited in the embodiments of this application.

In some embodiments, a plurality of servers may form a blockchain, and the server is a node on the blockchain. Each node in the blockchain may have an information connection, and the nodes may perform information transmission through the information connection. Data (for example, the motion sequence sample and the motion completion model) related to the method for training a motion completion model provided in the embodiments of this application may be stored on the blockchain.

In some embodiments, the terminal or the server may implement the method for training a motion completion model provided in the embodiments of this application by running a computer program. For example, the computer program may be a native program or a software module in an operating system; may be a native application (APP), that is, a program that needs to be installed in an operating system to run; may be an applet, that is, a program that only needs to be downloaded to a browser environment to run; or may be an applet that can be embedded into any APP. In conclusion, the computer program may be an application, a module, or a plug-in in any form.

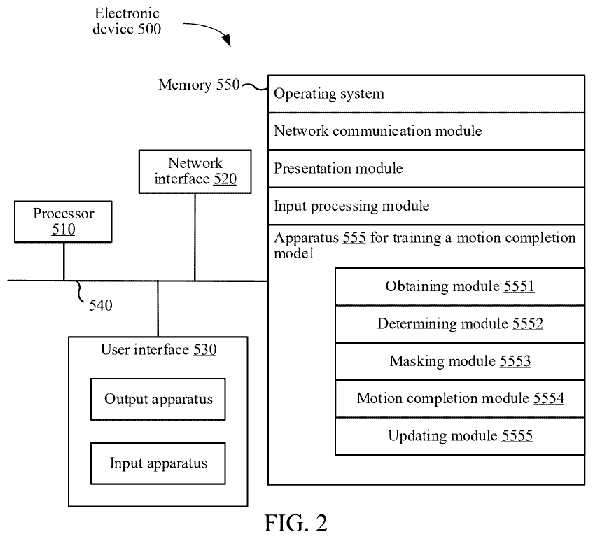

The following describes the electronic device implementing the method for training a motion completion model provided in the embodiments of this application. FIG. 2 is a schematic structural diagram of an electronic device 500 implementing a method for training a motion completion model according to an embodiment of this application. The electronic device 500 provided in this embodiment of this application may be a terminal or a server. The electronic device 500 provided in this embodiment of this application includes: at least one processor 510, a memory 550, at least one network interface 520, and a user interface 530. Components in the electronic device 500 are coupled together through a bus system 540. The bus system 540 is configured to implement connection and communication between these components. In addition to a data bus, the bus system 540 further includes a power bus, a control bus, and a status signal bus. However, for clear description, all types of buses are marked as the bus system 540 in FIG. 2.

In some embodiments, the apparatus for training a motion completion model provided in the embodiments of this application may be implemented by using software. FIG. 2 shows an apparatus 555 for training a motion completion model stored in the memory 550. The apparatus 555 may be software in a form such as a program or a plug-in, and includes the following software modules: an obtaining module 5551, a determining module 5552, a masking module 5553, a motion completion module 5554, and an updating module 5555. These modules are logical, and therefore may be combined or further split in different manners to form other embodiments. The functions of the modules are described below.

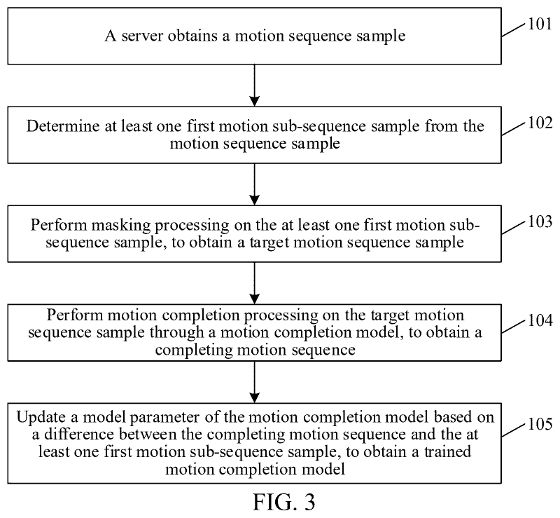

The following describes a method for training a motion completion model provided in the embodiments of this application. In some embodiments, the method for training a motion completion model provided in the embodiments of this application may be implemented by various electronic devices, for example, may be separately implemented by a terminal, or may be separately implemented by a server, or may be collaboratively implemented by a terminal and a server. That the server implements the method is used as an example. FIG. 3 is a schematic flowchart of a method for training a motion completion model according to an embodiment of this application. The method for training a motion completion model provided in the embodiments of this application includes the following operations.

Operation 101: The server obtains a motion sequence sample.

The motion sequence sample includes at least three consecutive motion frames.

In an actual application, a user may trigger a model training instruction for the motion completion model through a client (for example, a client supporting motion completion model training) configured in the terminal, so that the terminal transmits a model training request for the motion completion model to the server in response to the model training instruction. When receiving the model training request transmitted by the terminal, the server trains the motion completion model in response to the model training request. In operation 101, when training the motion completion model, the server first obtains a sample for training the motion completion model, namely, the motion sequence sample. The motion sequence sample includes at least three consecutive motion frames. For example, the motion sequence sample may include at least three consecutive dance motion frames included in a dance performance.

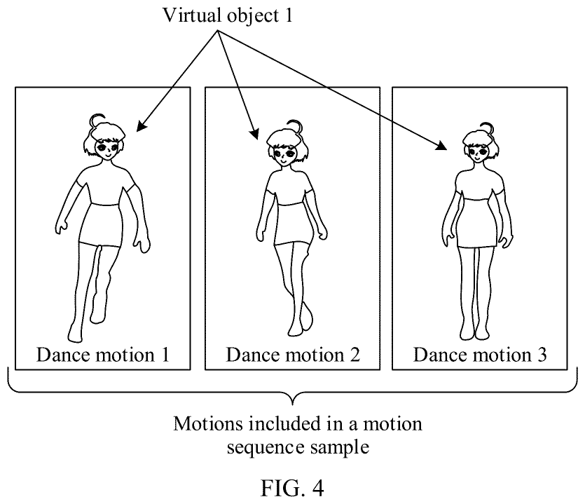

In some embodiments, the motion sequence sample are for an object. In other words, the motion sequence sample includes at least three consecutive motion frames of the object. The object may be a real human or object (for example, an animal), or may be a virtual human or object (for example, a virtual animal), such as a digital human, a virtual human, a virtual character in a virtual scene (for example, a game), a cartoon character in a cartoon or an animation, or a special effect character in a movie or TV play. For example, FIG. 4 is a schematic diagram of motion frames included in a motion sequence sample according to an embodiment of this application. The motion sequence sample is a dance motion sequence of a virtual object 1, and includes three consecutive dance motion frames of the virtual object 1: a dance motion frame 1, a dance motion frame 2, and a dance motion frame 3.

In some embodiments, if a motion frame similarity between two adjacent motion frames is not less than a similarity threshold (where the similarity threshold may be preset), the two adjacent motion frames may be considered as consecutive motion frames. That the motion sequence sample includes at least three consecutive motion frames represents that, in the motion sequence sample, the motion frame similarity between every two adjacent motion frames is not less than the similarity threshold. When the motion frame similarity between two adjacent motion frames is less than the similarity threshold, the two adjacent motion frames are considered as inconsecutive motion frames.

In some embodiments, a plurality of motion sequence samples may be provided, so that the motion completion model may be trained by each motion sequence sample, to improve a model training effect of the motion completion model. Frame quantities of motion frames included in each motion sequence sample may be the same or different, which is not limited in the embodiments of this application.

Operation 102: Determine at least one first motion sub-sequence sample from the motion sequence sample.

The first motion sub-sequence sample has two second motion sub-sequence samples adjacent thereto. The first motion sub-sequence sample and the second motion sub-sequence samples each include at least one of the motion frames, and the motion frame included in the second motion sub-sequence sample also belongs to the motion sequence sample.

After the motion sequence sample is obtained, in operation 102, at least one first motion sub-sequence sample is determined from the motion sequence sample. The at least one first motion sub-sequence sample belongs to the motion sequence sample, and each first motion sub-sequence sample has two second motion sub-sequence samples adjacent thereto. The second motion sub-sequence sample also belongs to the motion sequence sample, and the second motion sub-sequence sample is a motion sub-sequence sample in the motion sequence sample other than the at least one first motion sub-sequence sample. The first motion sub-sequence sample and the second motion sub-sequence samples each include at least one of the motion frames in the motion sequence sample.

That the first motion sub-sequence sample has two second motion sub-sequence samples adjacent thereto means that the first motion frame in the first motion sub-sequence sample and the last motion frame in the second motion sub-sequence sample are consecutive, and the last motion frame of the first motion sub-sequence sample and the first motion frame of the other second motion sub-sequence sample are consecutive.

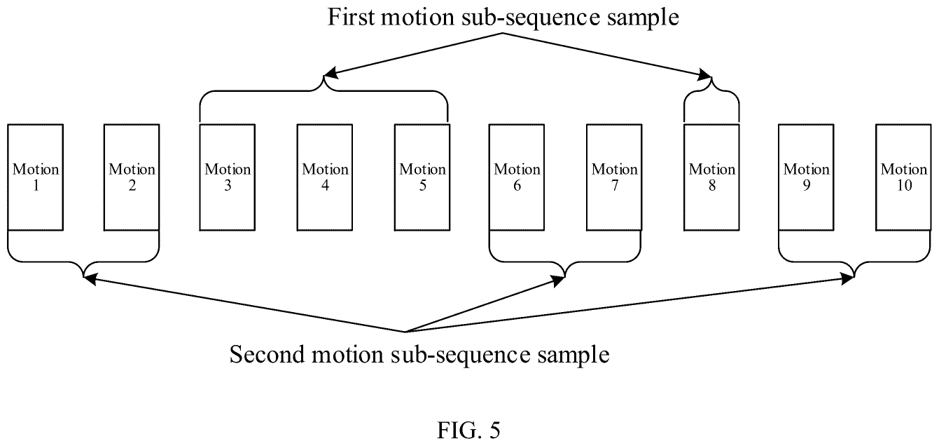

For example, FIG. 5 is a schematic diagram of a first motion sub-sequence sample and a second motion sub-sequence sample according to an embodiment of this application. The motion sequence sample includes 10 consecutive motion frames: “a motion frame 1 to a motion frame 10”. “The motion frame 3 to the motion frame 5” is a first motion sub-sequence sample, and “the motion frame 8” is a first motion sub-sequence sample. “The motion frame 1 and the motion frame 2” and “the motion frame 6 and the motion frame 7” are two second motion sub-sequence samples adjacent to “the motion frame 3 to the motion frame 5”. In other words, the first motion frame “the motion frame 3” in the first motion sub-sequence sample “the motion frame 3 to the motion frame 5” and the last motion frame “the motion frame 2” in the second motion sub-sequence sample “the motion frame 1 and the motion frame 2” are consecutive. The last motion frame “the motion frame 5” in the first motion sub-sequence sample “the motion frame 3 to the motion frame 5” and the first motion frame “the motion frame 6” in the second motion sub-sequence sample “the motion frame 6 and the motion frame 7” are consecutive. “The motion frame 6 and the motion frame 7” and “the motion frame 9 and the motion frame 10” are two second motion sub-sequence samples adjacent to “the motion frame 8”. In other words, the first motion sub-sequence sample “the motion frame 8” and the last motion frame “the motion frame 7” in the second motion sub-sequence sample “the motion frame 6 and motion frame 7” are consecutive, and the first motion sub-sequence sample “motion frame 8” and the first motion frame “the motion frame 9” in the second motion sub-sequence sample “the motion frame 9 and motion frame 10” are consecutive.

In some embodiments, the server may determine the at least one first motion sub-sequence sample from the motion sequence sample in the following manner: obtaining a sequence length range for determining the first motion sub-sequence sample and a total sequence length of the at least one first motion sub-sequence sample, where the total sequence length is less than a motion sequence length of the motion sequence sample; selecting at least one sub-sequence length in the sequence length range, where a sum of the at least one sub-sequence length is equal to the total sequence length; and determining, for each of the at least one sub-sequence length, a first motion sub-sequence sample having the sub-sequence length from the motion sequence sample.

The sequence length range corresponding to the first motion sub-sequence sample may be preset. In other words, a sub-sequence length of each first motion sub-sequence sample needs to fall within the sequence length range. In an actual application, the sub-sequence length may be indicated by a quantity of motion frames included in the first motion sub-sequence sample. For example, the first motion sub-sequence sample includes five motion frames, so that the sub-sequence length of the first motion sub-sequence sample is 5. In addition, the total sequence length of the determined at least one first motion sub-sequence sample may further be set, and it needs to be ensured that the total sequence length is less than the motion sequence length of the motion sequence sample. Similarly, the motion sequence length may be represented by a quantity of motion frames included in the motion sequence sample. For example, the motion sequence sample includes ten motion frames, so that the motion sequence length of the motion sub-sequence sample is 10.

In an actual application, in a process of determining the at least one first motion sub-sequence sample from the motion sequence sample, the sequence length range (for example, [3, 6]) corresponding to the first motion sub-sequence sample and the total sequence length (for example, 12) of the at least one first motion sub-sequence sample may be first obtained. At least one sub-sequence length in the sequence length range is then selected while ensuring that a sum of the at least one sub-sequence length that is selected is equal to the total sequence length, for example, the selected sub-sequence lengths are 3, 4, 5, respectively. The sub-sequence length may be randomly selected. Based on this, the first motion sub-sequence samples having the sub-sequence lengths may be determined from the motion sequence sample, to obtain the at least one first motion sub-sequence sample. In this way, the first motion sub-sequence sample can be properly determined, to subsequently provide a more proper input for training the motion completion model, and further improve a training effect of the motion completion model and precision of the trained motion completion model.

In some embodiments, for each of the at least one sub-sequence length, the server may determine the first motion sub-sequence sample having the sub-sequence length from the motion sequence sample in the following manner: determining at least one target motion frame from the motion sequence sample, where each of the at least one target motion frame is corresponding to one of the at least one sub-sequence length; and respectively performing the following processing for each target motion frame: determining a motion frame quantity corresponding to the sub-sequence length corresponding to the target motion frame; and determining, by using the target motion frame in the motion sequence sample as a starting motion frame, consecutive first motion frames corresponding to the motion frame quantity, and determining the first motion frames corresponding to the motion frame quantity as the first motion sub-sequence sample.

During determining of the first motion sub-sequence sample having the sub-sequence length, at least one target motion frame may be determined from the motion frames included in the motion sequence sample, where each of the at least one target motion frame is corresponding to the at least one sub-sequence length. In other words, for each of the at least one sub-sequence length, a target motion frame is determined, so that a quantity of target motion frames is the same as a quantity of selected sub-sequence lengths. Each determined target motion frame is different. Therefore, the following processing is performed for each target motion frame. The motion frame quantity corresponding to the sub-sequence length corresponding to the target motion frame is first determined. In an actual application, the sub-sequence length may be indicated by the motion frame quantity. In other words, a correspondence exists between the sub-sequence length and the motion frame quantity. For example, the sub-sequence length is the motion frame quantity, for example, the motion frame quantity is five, so that the sub-sequence length is 5. The consecutive first motion frames corresponding to the motion frame quantity are then determined by using the target motion frame in the motion sequence sample as the starting motion frame, so that the first motion frames corresponding to the motion frame quantity are determined as the first motion sub-sequence sample. In other words, the first motion sub-sequence sample is a motion sequence that uses the target motion frame as the first motion frame and has motion frames corresponding to the motion frame quantity, and every two adjacent motion frames in the motion frames corresponding to the motion frame quantity are consecutive.

In some embodiments, each motion frame in the motion sequence sample has a motion frame serial number, and the server may determine the at least one target motion frame from the motion sequence sample in the following manner: selecting at least one target motion frame serial number from the motion frame serial numbers of the motion frames in the motion sequence sample, where a quantity of the at least one target motion frame serial number is the same as a quantity of the at least one sub-sequence length; and determining a motion frame having the at least one target motion frame serial number from the motion sequence sample as the at least one target motion frame. The at least one target motion frame serial number may be randomly selected from the motion frame serial numbers corresponding to the motion frames in the motion sequence sample, so that a motion frame corresponding to each target motion frame serial number in the motion sequence sample is determined as the target motion frame. In this way, selection of the same target motion frame can be avoided, and a speed of determining the target motion frame can be improved, thereby improving training efficiency of the motion completion model.

When there are a plurality of first motion sub-sequence samples, the first motion sub-sequence samples may be completely non-overlapping. In other words, there is no case in which a plurality of first motion sub-sequence samples include a same motion frame. Certainly, there may alternatively be a case in which some first motion sub-sequence samples overlap in the plurality of first motion sub-sequence samples. In other words, there is a case in which a plurality of first motion sub-sequence samples include a same motion frame or a plurality of same motion frames. This is not limited in the embodiments of this application.

In some embodiments, the at least one first motion sub-sequence sample includes at least one of the following types of motion sub-sequence samples: a first-type motion sub-sequence sample or a second-type motion sub-sequence sample. The first-type motion sub-sequence sample includes one motion frame, and the second-type motion sub-sequence sample includes at least two consecutive motion frames. When the at least one first motion sub-sequence sample includes a plurality of first-type motion sub-sequence samples, motion frames included in the first-type motion sub-sequence samples are inconsecutive.

Two types of first motion sub-sequence samples are provided: the first-type motion sub-sequence sample and the second-type motion sub-sequence sample. The at least one first motion sub-sequence sample may include at least one of the first-type motion sub-sequence sample or the second-type motion sub-sequence sample. The first-type motion sub-sequence sample includes one motion frame in the motion sequence sample, and when the at least one first motion sub-sequence sample includes a plurality of first-type motion sub-sequence samples, motion frames included in the first-type motion sub-sequence samples are inconsecutive. For example, the motion sequence sample includes “the motion frame 1 to the motion frame 5”, and the first-type motion sub-sequence sample may be “the motion frame 1” or “the motion frame 4”. The second-type motion sub-sequence sample includes at least two consecutive motion frames in the motion sequence sample. For example, the motion sequence sample includes “the motion frame 1 to the motion frame 5”, and the second-type motion sub-sequence sample may be “the motion frame 2 and the motion frame 3”.

In some embodiments, there are a plurality of first motion sub-sequence samples, and the plurality of first motion sub-sequence samples include the first-type motion sub-sequence sample and the second-type motion sub-sequence sample. Correspondingly, the server may determine the at least one first motion sub-sequence sample from the motion sequence sample in the following manner: obtaining a first motion frame quantity corresponding to the first-type motion sub-sequence sample and a second motion frame quantity corresponding to the second-type motion sub-sequence sample; determining at least one first-type motion sub-sequence sample from the motion sequence sample, where a total quantity of motion frames included in the at least one first-type motion sub-sequence sample is the first motion frame quantity; and determining at least one second-type motion sub-sequence sample from the motion sequence sample, where a total quantity of motion frames included in the at least one second-type motion sub-sequence sample is the second motion frame quantity.

When a plurality of first motion sub-sequence samples that are to be determined include both the first-type motion sub-sequence sample and the second-type motion sub-sequence sample, a total motion frame quantity of motion frames included in each type of motion sub-sequence sample may be respectively set for the type of motion sub-sequence sample. For example, a total motion frame quantity of motion frames included in the first-type motion sub-sequence samples may be the first motion frame quantity, and a total motion frame quantity of motion frames included in the second-type motion sub-sequence sample may be the second motion frame quantity. Correspondingly, when the at least one first motion sub-sequence sample is determined, the first motion frame quantity and the second motion frame quantity may be obtained. Therefore, the at least one first-type motion sub-sequence sample is determined from the motion sequence sample, so that the total quantity of the motion frames included in the at least one first-type motion sub-sequence sample is the first motion frame quantity; and the at least one second-type motion sub-sequence sample is determined from the motion sequence sample, so that the total quantity of the motion frames included in the at least one second-type motion sub-sequence sample is the second motion frame quantity.

In an actual application, the first motion frame quantity (or the second motion frame quantity) may be set by the user based on an experience value; or may be automatically calculated by the server in a preset calculation manner. For example, in some embodiments, a motion frame proportion of motion frames in each type of motion sub-sequence sample to the motion frames in the motion sequence sample may be set, so that a motion frame quantity corresponding to a corresponding type of motion sub-sequence sample is determined based on the motion frame proportion. Based on this, the server may obtain the first motion frame quantity corresponding to the first-type motion sub-sequence sample and the second motion frame quantity corresponding to the second-type motion sub-sequence sample in the following manner: obtaining a first motion frame proportion corresponding to the first-type motion sub-sequence sample and a second motion frame proportion corresponding to the second-type motion sub-sequence sample; obtaining the total motion frame quantity of the motion frames included in the motion sequence sample; multiplying the first motion frame proportion by the total motion frame quantity, to obtain the first motion frame quantity; and multiplying the second motion frame proportion by the total motion frame quantity, to obtain the second motion frame quantity.

Based on the foregoing embodiment, different types of first motion sub-sequence samples are determined, diversity of subsequently generated samples (namely, target motion sequence samples) for being inputted to the motion completion model is improved, thereby improving a training effect of the motion completion model, so that precision and robustness of motion completion of the trained motion completion model are higher.

Operation 103: Perform masking processing on the at least one first motion sub-sequence sample, to obtain a target motion sequence sample.

After the at least one first motion sub-sequence sample is determined, in operation 103, masking processing is performed on the at least one first motion sub-sequence sample in the motion sequence sample, to obtain the target motion sequence sample. Performing masking processing on the at least one first motion sub-sequence sample means performing masking processing on the motion frame parameter of the motion frame included in the at least one first motion sub-sequence sample. In addition, for each motion frame parameter, the masking processing means performing one of the following processing on the motion frame parameter: (1) setting the motion frame parameter to a specific value (for example, 0); (2) setting the motion frame parameter to a random value; or (3) maintaining the motion frame parameter unchanged.

In some embodiments, the motion sequence sample includes: motion frame parameters of the motion frames in the motion sequence sample. Correspondingly, the server may perform masking processing on the at least one first motion sub-sequence sample in the motion sequence sample in the following manner, to obtain the target motion sequence sample: determining, from the motion frame parameters of the motion frames in the motion sequence sample, a target motion frame parameter of a motion frame included in the at least one first motion sub-sequence sample; and performing masking processing on the motion frame parameter of the motion frame included in the at least one first motion sub-sequence sample, to obtain the target motion sequence sample.

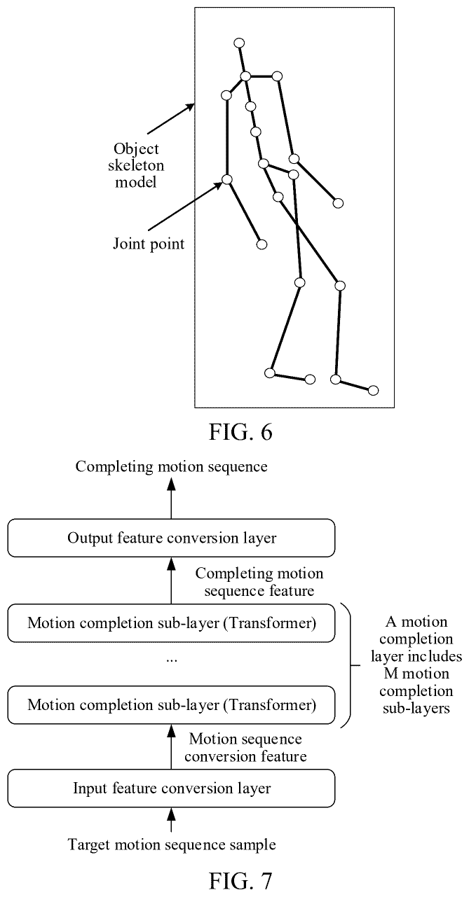

The motion sequence sample includes: the motion frame parameters of the motion frames in the motion sequence sample. In an actual application, the motion frames in the motion sequence sample is for an object (for example, a human or an animal). The motion frame parameter may include: joint data of each joint point in an object skeleton model of the object in the motion frame. The joint data includes at least one of the following data: a rotation angle of each joint point, bone data (such as a bone direction and a bone length) of a bone connected to each joint point, a connection relationship between different joint points, and the like. For example, FIG. 6 is a schematic diagram of an object skeleton model according to an embodiment of this application. The object skeleton model is a human skeleton model, parts indicated by circles are some joint points of the object skeleton model, and each joint point has corresponding joint data. For example, if an arm is hung naturally, an angle of a shoulder joint point is 0 degrees (where the shoulder is connected to the arm); if the arm is lifted flush with the chest, the angle of the shoulder joint point is 90 degrees; and if the arm is lifted vertically, the angle of the shoulder joint point is 180 degrees.

In an actual application, the object skeleton model has different quantities of joint points based on different models, and joint data of each joint point is expressed in a different manner, but may be considered as a vector in several dimensions (generally in 3 dimensions or in 4 dimensions). The motion frame parameter of each motion frame is: a vector formed by connecting vectors in the several dimensions corresponding to each joint point in the object skeleton model.

During masking processing, the target motion frame parameter of the motion frame included in the at least one first motion sub-sequence sample may be determined from the motion frame parameters of the motion frames in the motion sequence sample, so that marking processing is performed on the target motion frame parameter, to obtain the target motion sequence sample. The target motion frame parameter is motion frame parameters of all motion frames included in the at least one first motion sub-sequence sample, but not a motion frame parameter of a motion frame included in a specific first motion sub-sequence sample.

In some embodiments, the server may perform masking processing on the motion frame parameter of the motion frame included in the at least one first motion sub-sequence sample in the following manner, to obtain the target motion sequence sample: obtaining a masking processing mode for masking processing; and performing, in the masking processing mode, masking processing on the motion frame parameter of the motion frame included in the at least one first motion sub-sequence sample, to obtain the target motion sequence sample. The masking processing mode includes at least one of the following: setting the target motion frame parameter to a target value, setting the target motion frame parameter to a random value, or maintaining the target motion frame parameter unchanged.

There are three types of masking processing modes for the masking processing: (1) setting the target motion frame parameter to a target value, for example, setting the target motion frame parameter to 0; (2) setting the target motion frame parameter to a random value, where the random value may be a random value generated through a random number generation algorithm and based on the target motion frame parameter; and (3) maintaining the target motion frame parameter unchanged. Based on this, during masking processing, masking processing may be performed on the target motion frame parameter in at least one of the three masking processing modes, to obtain the target motion sequence sample. In this way, a plurality of masking processing modes are provided for performing masking processing on the first motion sub-sequence sample, improving diversity of subsequently generated samples (namely, the target motion sequence samples) for being inputted to the motion completion model, so that a learning capability and a training effect of the motion completion model are improved, and precision of the motion completion of the trained motion completion model is higher.

In some embodiments, the at least one first motion sub-sequence sample includes a plurality of motion frames, and there are a plurality of target motion frame parameters. Correspondingly, when there are a plurality of masking processing modes, the server may performing masking processing on the target motion frame parameter of the motion frame included in the at least one first motion sub-sequence sample in the masking processing modes in the following manner, to obtain the target motion sequence sample: obtaining a masking processing proportion corresponding to each of the masking processing modes; determining a to-be-masked motion frame parameter corresponding to each of the masking processing modes from the plurality of target motion frame parameters based on each masking processing proportion; and performing masking processing on a corresponding to-be-masked motion frame parameter by using each of the masking processing modes, to obtain the target motion sequence sample.

When there are a plurality of masking processing modes for masking processing, each of the masking processing modes may have a corresponding masking processing proportion, and the masking processing proportion is configured for indicating a proportion of a quantity of to-be-masked motion frame parameters on which masking processing is performed in the masking manner to a quantity of the target motion frame parameters. In an actual application, the masking processing proportion corresponding to each of the masking processing modes may be preset, for example, set based on an experience value, or may be randomly generated based on a quantity of used masking processing modes.

In an actual application, during masking processing performed on the target motion frame parameter, the masking processing proportion corresponding to each of the masking processing modes may be first obtained; and the to-be-masked motion frame parameter corresponding to each of the masking processing modes is then determined from the plurality of target motion frame parameters based on each masking processing proportion. For example, the masking processing proportions corresponding to the masking processing modes are respectively: A masking processing proportion of a masking processing mode 1 is 30%, a masking processing proportion of a masking processing mode 2 is 20%, and a masking processing proportion of a masking processing mode 3 is 50%. The plurality of target motion frame parameters include: motion frame parameters 1 to 10. In this case, the plurality of target motion frame parameters may be grouped into three parts. A quantity of target motion frame parameters of a first part accounts for 30% of a total quantity of target motion frame parameters. The target motion frame parameters of the first part are to-be-masked motion frame parameters corresponding to the masking processing mode 1, for example, the motion frame parameters 1 to 3. A quantity of target motion frame parameters of a second part accounts for 20% of the total quantity of target motion frame parameters. The target motion frame parameters of the second part are to-be-masked motion frame parameters corresponding to the masking processing mode 2, for example, the motion frame parameters 4 and 5. A quantity of target motion frame parameters of a third part accounts for 50% of the total quantity of target motion frame parameters. The target motion frame parameters of the third part are to-be-masked motion frame parameters corresponding to the masking processing mode 3, for example, the motion frame parameters 6 to 10. Based on this, masking processing is performed, in the masking processing modes respectively, on the to-be-masked motion frame parameters corresponding to the masking processing modes, to obtain the target motion sequence sample. In this way, masking processing is performed on the first motion sub-sequence samples in the motion sequence sample based on the corresponding masking processing proportion in a plurality of masking processing modes, improving diversity of each obtained target motion sequence sample, and further enriching diversity of samples (namely, the target motion sequence samples) for being inputted to the motion completion model, so that the learning capability and the training effect of the motion completion model are improved, the precision of motion completion of the trained motion completion model is higher, and an effect of motion completion is better.

Operation 104: Perform motion completion processing on the target motion sequence sample through the motion completion model, to obtain a completing motion sequence.

After the target motion sequence sample is obtained, in operation 104, the motion completion processing is performed on the target motion sequence sample through the motion completion model, to obtain the completing motion sequence. The motion completion processing means predicting, through the motion completion model, a motion sequence configured for completing the target motion sequence sample, to obtain the completing motion sequence. In an actual application, during masking processing, masking processing is performed on the target motion frame parameters of the motion frames included in the at least one first motion sub-sequence sample. Therefore, in operation 104, during motion completion processing, motion frame parameter prediction may be performed, through the motion completion model, on the at least one first motion sub-sequence sample that is masked, to obtain a predicted motion frame parameter, and the predicted motion frame parameter is the completing motion sequence.

In some embodiments, the motion completion model includes an input feature conversion layer, a motion completion layer, and an output feature conversion layer. Correspondingly, the server may perform motion completion processing on the target motion sequence sample through the motion completion model in the following manner, to obtain the completing motion sequence: performing feature conversion on the target motion sequence sample through the input feature conversion layer, to obtain a motion sequence conversion feature; performing motion completion processing on the motion sequence conversion feature through the motion completion layer, to obtain a completing motion sequence feature; and performing feature conversion on the completing motion sequence feature through the output feature conversion layer, to obtain the completing motion sequence.

The motion completion model includes the input feature conversion layer, the motion completion layer, and the output feature conversion layer. When the motion completion processing is performed on the target motion sequence sample through the motion completion model, an input of the motion completion model (namely, the target motion sequence sample) may be first converted into an input feature that can be inputted into the motion completion layer. In other words, feature conversion is performed on the target motion sequence sample inputted to the motion completion model through the input feature conversion layer, to obtain the motion sequence conversion feature. The motion sequence conversion feature meets a standard of the input feature (for example, a dimension of the input feature) of the motion completion layer. The motion sequence conversion feature is then inputted to the motion completion layer, and motion completion processing is performed on the motion sequence conversion feature through the motion completion layer, to obtain the completing motion sequence feature. An output of the motion completion layer is finally converted into a feature that meets an output standard (for example, a dimension of the output feature) of the motion completion model. In other words, feature conversion is performed on the completing motion sequence feature through the output feature conversion layer, to obtain the completing motion sequence. In this way, a motion completion model constructed through a sequence processing model (for example, a Transformer model) can be implemented, so that motion completion processing can be directly performed on a plurality of inconsecutive motion sequences without converting a data format of the motion sequences (for example, converting the motion sequences into images), thereby improving efficiency of the motion completion processing.

In some embodiments, the motion completion layer may include M cascaded motion completion sub-layers. Based on this, the server may perform motion completion processing on the motion sequence conversion feature through the motion completion layer in the following manner, to obtain the completing motion sequence feature: performing motion completion processing on the motion sequence conversion feature through a 1^{st} motion completion sub-layer in the M cascaded motion completion sub-layers, to obtain an intermediate completing motion sequence feature of the 1^{st} motion completion sub-layer; performing motion completion processing on an intermediate completing motion sequence feature of an (n−1)^{th} motion completion sub-layer through an n^{th} motion completion sub-layer in the M cascaded motion completion sub-layers, to obtain an intermediate completing motion sequence feature of the n^{th} motion completion sub-layer; and traversing the n intermediate completing motion sequence features to obtain an intermediate completing motion sequence feature of an M^{th} motion completion sub-layer, and determining the intermediate completing motion sequence feature of the M^{th} motion completion sub-layer as the completing motion sequence feature. M and n are integers greater than 1, and n is less than or equal to M. In this way, the motion completion layer is formed by using a plurality of cascaded motion completion sub-layers, which can improve precision of motion completion processing and provide the motion completion effect.

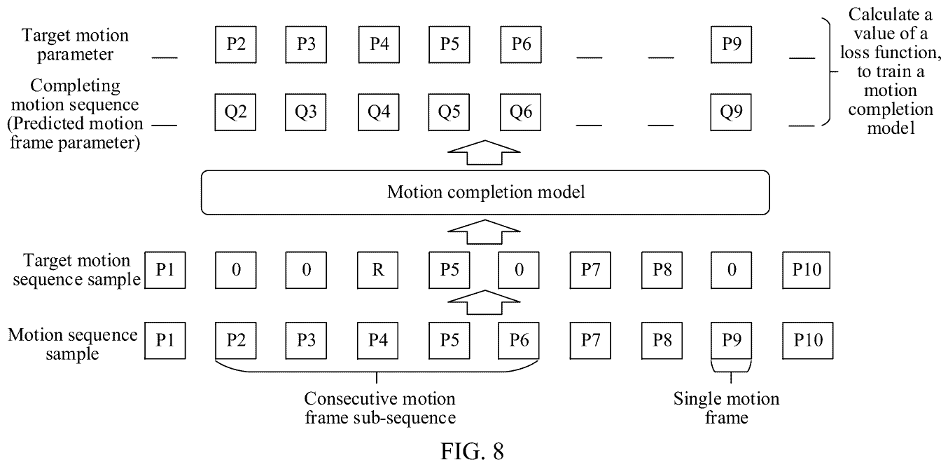

For example, FIG. 7 is a schematic structural diagram of a motion completion model according to an embodiment of this application. A target motion sequence sample is represented by (L, d). A sequence length of the target motion sequence sample is L (for example, L=10) motion frames, and a dimension of a target motion frame parameter of each motion frame in the target motion sequence sample is d (for example, d=5) dimensions. S1: Perform feature conversion on the target motion sequence sample (L, d) through the input feature conversion layer, to obtain a motion sequence conversion feature (L, d1), where a dimension of the motion sequence conversion feature is d1 (for example, d1=3). S2: Perform motion completion processing on the motion sequence conversion feature (L, d1) through the motion completion layer, to obtain a completing motion sequence feature (L, d2), where a dimension of the motion sequence conversion feature is d2 (for example, d2=3). During actual implementation, the dimension d2 of the output feature of the motion completion layer may be the same as the dimension d1 of the motion sequence conversion feature. The motion completion layer may include M cascaded motion completion sub-layers, and each motion completion sub-layer is implemented through a sequence processing model (for example, a Transformer model). S3: Perform feature conversion on the completing motion sequence feature (L, d2) through the output feature conversion layer, to obtain the completing motion sequence. During actual implementation, the completing motion sequence includes: the predicted motion frame parameter obtained by performing motion frame parameter prediction on each masked first motion sub-sequence sample. Therefore, a dimension of each predicted motion frame parameter is also d.

Operation 105: Update a model parameter of the motion completion model based on a difference between the completing motion sequence and the at least one first motion sub-sequence sample, to obtain a trained motion completion model.

The trained motion completion model is configured for performing motion completion processing on at least two motion sequences, to obtain a target motion sequence. Motion frames of the at least two motion sequences are inconsecutive, and the target motion sequence is configured to cause the motion frames of the at least two motion sequences to be consecutive.

After the completing motion sequence is obtained, because masking processing is performed on each first motion sub-sequence sample in the motion sequence sample, when motion completion processing is performed through the motion completion model, the obtained completing motion sequence includes a sub-completing motion sequence corresponding to each first motion sub-sequence sample. Therefore, in operation 105, when the difference between the completing motion sequence and the at least one first motion sub-sequence sample is obtained, a difference between each first motion sub-sequence sample and the corresponding sub-completing motion sequence is actually obtained, so that the model parameter of the motion completion model is updated based on the obtained difference, to train the motion completion model.

In some embodiments, a value of a loss function of the motion completion model is determined based on the difference between the completing motion sequence and the at least one first motion sub-sequence sample, so that the model parameter of the motion completion model is updated based on the value of the loss function, to train the motion completion model. When the model parameter of the motion completion model is updated based on the value of the loss function, whether the value of the loss function exceeds a loss threshold is first determined. When the value of the loss function exceeds the loss threshold, an error signal of the motion completion model is determined based on the loss function, and the error signal is back-propagated in the motion completion model, to update a model parameter of each layer in the motion completion model during back propagation of the error signal. Training the motion completion model is performing iterative training on the motion completion model, that is, performing a plurality of rounds of training processes of the motion completion model provided in the embodiments of this application on the motion completion model, so that a model parameter of the motion completion model outputted in a previous round of training is updated into a model parameter of the motion completion model outputted in a current round of training, to obtain the motion completion model obtained in the current round of training. In addition, during each round of training, after the motion completion model obtained in the current round of training is obtained, whether the motion completion model reaches a training target is further determined. The training target may be that a verification indicator (for example, an error or accuracy of motion completion) of the motion completion model on a verification set reaches an indicator threshold (which may be preset), or may be that a quantity of rounds of training reaches a round number threshold (which may be preset). When it is determined that the motion completion model does not reach the training target, a next round of training is continued to be performed on the motion completion model; or when it is determined that the motion completion model reaches the training target, the training is stopped, and the motion completion model obtained in the last round of training is outputted as a final motion completion model. In this way, training precision of the motion completion model can be improved, and training efficiency of the motion completion model can be ensured, thereby improving the training effect of the motion completion model.

In some embodiments, the server may perform motion completion processing on the target motion sequence sample through the motion completion model in the following manner, to obtain the completing motion sequence: performing, through the motion completion model, motion frame parameter prediction on the at least one first motion sub-sequence sample that is masked in the target motion sequence sample, to obtain the predicted motion frame parameter, and determining the predicted motion frame parameter as the completing motion sequence. Correspondingly, the server may update the model parameter of the motion completion model based on the difference between the completing motion sequence and the at least one first motion sub-sequence sample in the following manner: determining the value of the loss function of the motion completion model based on a difference between the predicted motion frame parameter and the target motion frame parameter; and updating the model parameter of the motion completion model based on the value of the loss function.

During masking processing performed on the at least one first motion sub-sequence sample, masking processing is performed on the target motion frame parameter corresponding to the at least one first motion sub-sequence sample. Therefore, when motion completion processing is performed, motion frame parameter prediction is performed on the at least one first motion sub-sequence sample that is masked in the target motion sequence sample through the motion completion model, to obtain the predicted motion frame parameter. The predicted motion frame parameter is the completing motion sequence. Correspondingly, when the motion completion model is trained, the model parameter of the motion completion model may be updated based on the difference between the predicted motion frame parameter and the target motion frame parameter. Specifically, the value of the loss function of the motion completion model is determined based on the difference between the predicted motion frame parameter and the target motion frame parameter, so that the model parameter of the motion completion model is updated based on the value of the loss function.

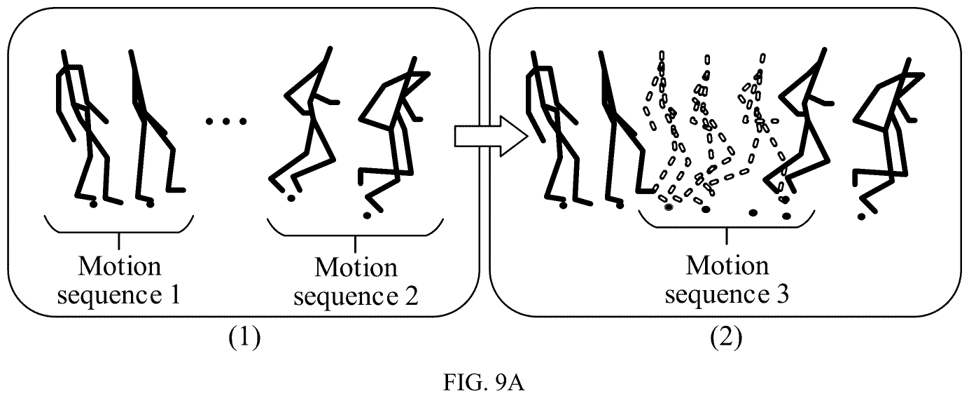

FIG. 8 is a schematic diagram of an example of training of a motion completion model according to an embodiment of this application. In this example, as shown in FIG. 8, the motion sequence samples include 10 consecutive motion frames: P1 to P10. Two first motion sub-sequence samples are determined from the motion sequence sample, which are respectively a first-type motion sub-sequence sample: a single motion frame “P9”, and a second-type motion sub-sequence sample: a consecutive motion frame sub-sequence “P2 to P6” (including 5 consecutive motion frames). Performing masking processing on two first motion sub-sequence samples in the motion sequence sample is performing masking processing on motion frame parameters of motion frames included in the two first motion sub-sequence samples, to obtain the target motion sequence sample. For each motion frame parameter, the masking processing means performing one of the following processing on the motion frame parameter: (1) setting the motion frame parameter to a specific value (for example, 0); (2) setting the motion frame parameter to a random value; or (3) maintaining the motion frame parameter unchanged. For example, a motion frame parameter of the single motion frame “P9” may be set to 0, motion frame parameters of “P2, P3, and P6” in the consecutive motion frame sub-sequence “P2 to P6” may be set to 0, a motion frame parameter of “P4” in the consecutive motion frame sub-sequence “P2 to P6” may be set to a random value “R”, and a motion frame parameter of “P5” in the consecutive motion frame sub-sequence “P2 to P6” may be maintained unchanged, to implement masking processing. Motion completion processing is performed on the target motion sequence sample through the motion completion model, to obtain the completing motion sequence. To be specific, motion frame parameter prediction is performed on the at least one first motion sub-sequence sample that is masked in the target motion sequence sample through the motion completion model, to obtain predicted motion frame parameters “Q2 to Q6” and “Q9”. The value of the loss function of the motion completion model is determined based on the difference between the predicted motion frame parameter and the target motion frame parameter, so that the model parameter of the motion completion model is updated based on the value of the loss function, to train the motion completion model, to obtain the trained motion completion model.

During motion completion processing, at least two motion sequences on which motion completion processing is to be performed may be obtained. Motion frames of the at least two motion sequences are inconsecutive. Motion completion processing is performed on the at least two motion sequences by invoking the trained motion completion model, to obtain the target motion sequence. The target motion sequence is configured to cause the motion frames of the at least two motion sequences to be consecutive. The target motion sequence predicted and outputted by the motion completion model includes a sub-target motion sequence required between every two adjacent motion sequences in the at least two motion sequences (where the sub-target motion sequence includes one motion frame or a plurality of consecutive motion frames), and the sub-target motion sequences are arranged based on positions at which the sub-target motion sequences are to be placed in the at least two motion sequences. Therefore, the sub-target motion sequences may be respectively placed at the to-be-placed positions in the at least two motion sequences for combination, to obtain the target completed motion sequence of the at least two motion sequences. That the motion frames of the at least two motion sequences are inconsecutive means that in every two adjacent motion sequences in the at least two motion sequences, a motion frame similarity between an end motion frame of a preceding motion sequence and a start motion frame of a following motion sequence is less than a similarity threshold. That the motion frames of the at least two motion sequences are consecutive means that in every two adjacent motion sequences in the at least two motion sequences, a motion frame similarity between an end motion frame of a preceding motion sequence and a start motion frame of a following motion sequence is not less than the similarity threshold. Each motion sequence includes one motion frame or a plurality of consecutive motion frames. When the motion sequence includes the plurality of consecutive motion frames, a motion frame similarity between every two adjacent motion frames in the plurality of motion frames is not less than the similarity threshold.

For example, when two motion sequences are provided, the motion sequences are sequentially a motion sequence 1 and a motion sequence 2. Motion frames of the two motion sequences are inconsecutive. In other words, a motion frame similarity between an end motion frame of the motion sequence 1 (a preceding motion sequence) and a start motion frame of the motion sequence 2 (a following motion sequence) is less than the similarity threshold. When the target motion sequence is obtained through the motion completion model, the target motion sequence may be placed between the two motion sequences, so that the target motion sequence becomes a transition between the two motion sequences, to cause the motion frames of the two motion sequences to be consecutive. In other words, a motion frame similarity between the end motion frame of the motion sequence 1 and a start motion frame of the target motion sequence is not less than the similarity threshold, and a motion frame similarity between an end motion frame of the target motion sequence and the start motion frame of the motion sequence 1 is not less than the similarity threshold.

For example, FIG. 9A is a schematic diagram of motion completion processing according to an embodiment of this application. As shown in (1) in FIG. 9A, two motion sequences are included: the motion sequence 1 and the motion sequence 2. In (1) in FIG. 9A, the motion frames of the motion sequence 1 and the motion sequence 2 are inconsecutive. To be specific, a significant sense of incontinuity exists between the last motion frame in the motion sequence 1 and the first motion frame in the motion sequence 2. In other words, a motion sequence is missing between the motion sequence 1 and the motion sequence 2. In the embodiments of this application, motion completion processing may be performed on “the motion sequence 1 and the motion sequence 2” through the motion completion model, to obtain the motion sequence 3. As shown in (2) in FIG. 9A, the motion sequence 3 is placed between the motion sequence 1 and the motion sequence 2, and the motion sequence 3 becomes a transition between the motion sequence 1 and the motion sequence 2, to cause motion frames of the motion sequence 1 and the motion sequence 2 to be consecutive, so that transition from the last motion frame in the motion sequence 1 to the first motion frame in the motion sequence 2 is smoother, and the sense of incontinuity is weakened. In other words, “the motion sequence 1—the motion sequence 3—the motion sequence 2” forms a motion sequence in which motion frames are consecutive, achieving motion completion.

In an actual application, the target motion sequence outputted by the motion completion model is the motion frame parameters of the motion frames included in the target motion sequence. The target motion sequence corresponds to an object (for example, a virtual human or a digital human). When an object having a corresponding motion frame is displayed based on the motion frame parameter of each motion frame, a position of each joint point may be obtained based on a rotation angle of each joint point in an object skeleton model of the object in the motion frame parameter and bone data (such as a bone direction and a bone length) of a bone connected to each joint point. Skinning is performed on the object skeleton model based on the position of the joint point and the bone data, and a result of the skinning is rendered, to display the object having each motion frame in the target motion sequence.

According to the embodiments of this application, at least one first motion sub-sequence sample is first determined from a motion sequence sample including at least three consecutive motion frames. The first motion sub-sequence sample has two second motion sub-sequence samples adjacent thereto. Masking processing is performed on the at least one first motion sub-sequence sample in the motion sequence sample, to obtain a target motion sequence sample. Motion completion processing is then performed on the target motion sequence sample through a motion completion model, to obtain a completing motion sequence, so that a model parameter of the motion completion model is updated based on a difference between the completing motion sequence and the at least one first motion sub-sequence sample that is masked, to train the motion completion model. In this way, a trained motion completion model is obtained.

Through the trained motion completion model, motion completion processing can be performed on at least two motion sequences in which motion frames of the motion sequences are inconsecutive, to obtain a target motion sequence. The target motion sequence enables the motion frames of the at least two motion sequences to be consecutive. In this way, when motion completion processing is performed on a motion sequence of an object (for example, a digital human or a virtual human) through the trained motion completion model, precision of the motion completion processing can be improved, and motion completion processing of two or more motion sequences in which motion frames are inconsecutive between the motion sequences can be implemented, thereby improving efficiency of the motion completion processing.

The following describes the motion completion method provided in the embodiments of this application. In some embodiments, the motion completion method provided in the embodiments of this application may be implemented by various electronic devices, for example, may be separately implemented by a terminal, or may be separately implemented by a server, or may be collaboratively implemented by a terminal and a server. That the terminal implements the method is used as an example. FIG. 9B is a schematic flowchart of a motion completion method according to an embodiment of this application. The motion completion method provided in the embodiments of this application includes the following operations.

Operation 201: The terminal obtains at least two motion sequences on which motion completion is to be performed.

Motion frames of the at least two motion sequences are inconsecutive.

In operation 201, when motion completion needs to be performed on the at least two motion sequences, a user may trigger a motion completion instruction for the at least two motion sequences on the terminal. The terminal obtains, in response to the motion completion instruction, at least two motion sequences on which motion completion is to be performed, where the motion frames are inconsecutive between the at least two motion sequences. That the motion frames of the at least two motion sequences are inconsecutive means that in every two adjacent motion sequences in the at least two motion sequences, a motion frame similarity between an end motion frame of a preceding motion sequence and a start motion frame of a following motion sequence is less than a similarity threshold. That the motion frames of the at least two motion sequences are consecutive means that in every two adjacent motion sequences in the at least two motion sequences, a motion frame similarity between an end motion frame of a preceding motion sequence and a start motion frame of a following motion sequence is not less than the similarity threshold. Each motion sequence includes one motion frame or a plurality of consecutive motion frames. When the motion sequence includes the plurality of consecutive motion frames, a motion frame similarity between every two adjacent motion frames in the plurality of motion frames is not less than the similarity threshold.

Operation 202: Perform motion completion processing on the at least two motion sequences by invoking a motion completion model, to obtain a target motion sequence.

The target motion sequence is configured to cause the motion frames of the at least two motion sequences to be consecutive, and the motion completion model is obtained through training based on the method for training a motion completion model provided in the embodiments of this application.

In operation 202, the motion completion model obtained through training based on the method for training a motion completion model provided in the embodiments of this application may be invoked to predict a motion sequence for completing the at least two motion sequence, to obtain the target motion sequence. The target motion sequence is configured for completing the at least two motion sequences, to cause the motion frames of the at least two motion sequences to be consecutive. In other words, after the target motion sequence and the at least two motion sequences are combined, a motion frame similarity between every two adjacent motion frames in the obtained target completed motion sequence is not less than the similarity threshold, that is, every two adjacent motion frames in the target completed motion sequence are consecutive.

Operation 203: Combine the target motion sequence and the at least two motion sequences, to obtain the target completed motion sequence of the at least two motion sequences.

In operation 203, the target motion sequence and the at least two motion sequences are combined, to obtain the target completed motion sequence of the at least two motion sequences. The target motion sequence predicted and outputted by the motion completion model includes a sub-target motion sequence required between every two adjacent motion sequences in the at least two motion sequences (where the sub-target motion sequence includes one motion frame or a plurality of consecutive motion frames), and the sub-target motion sequences are arranged based on positions at which the sub-target motion sequences are to be placed in the at least two motion sequences. For example, if the at least two motion sequences are “a motion sequence 1, a motion sequence 2, and a motion sequence 3”, the sub-target motion sequences are sequentially “a sub-target motion sequence 1 and a sub-target motion sequence 2”. The sub-target motion sequence 1 is a sub-target motion sequence required between the motion sequence 1 and the motion sequence 2, and the sub-target motion sequence 2 is a sub-target motion sequence required between the motion sequence 2 and the motion sequence 3. Therefore, during combination, the sub-target motion sequences may be respectively placed at the to-be-placed positions in the at least two motion sequences, to obtain the target completed motion sequence. For example, “the sub-target motion sequence 1 and the sub-target motion sequence 2” and “the motion sequence 1, the motion sequence 2, and the motion sequence 3” are combined, to obtain the target completed motion sequence: “the motion sequence 1, the sub-target motion sequence 1, the motion sequence 2, the sub-target motion sequence 2, and the motion sequence 3”.

According to the embodiments of this application, through the trained motion completion model, motion completion processing can be performed on at least two motion sequences in which motion frames are inconsecutive between motion sequences, to obtain a target motion sequence, where the target motion sequence enables the motion frames of the at least two motion sequences to be consecutive. In this way, when motion completion processing is performed on a motion sequence of an object (for example, a digital human or a virtual human) through the trained motion completion model, precision of the motion completion processing can be improved, and motion completion processing of two or more motion sequences in which motion frames are inconsecutive between the motion sequences can be implemented, thereby improving efficiency of the motion completion processing.

The following describes an exemplary application of the embodiments of this application in an actual application scenario. Before this embodiment of this application is described, a motion completion manner provided in the related art is first described. In the related art, motion completion is implemented through linear interpolation. To be specific, computation is performed based on an end motion frame and a start motion frame of two adjacent motion sequences and based on a given motion frame quantity of motion frames to be inserted, to obtain motion frames to be inserted. For example, an end motion frame of the motion sequence 1 is a, and a start motion frame of the motion sequence 2 is b. If n connecting motion frames are to be inserted, the i^{th} completion motion frame obtained through linear interpolation is

$${x}_{i} = \frac{( b - a ) * i}{n} + a .$$

Motion frames obtained by motion completion based on linear interpolation are not precise, and the efficiency of motion completion based on linear interpolation is not high.

A motion completion method is provided in the embodiments of this application, which is implemented through a motion completion model. The motion completion model is trained in the following manner: Assuming a motion frame segment with a length of Y (that is, including Y motion frames), where a dimension of a motion frame parameter of each motion frame is X, the motion frame segments form an original image with a size of X*Y, and each column is a motion frame at a time point. Then, a part with a size of X*Z (where Z is less than Y) is randomly deleted from the original image with the size of X*Y, the remaining part X*(Y−Z) is considered as an input of a convolutional neural network, and the original image is considered as an expected output, to train the motion completion model. However, this solution is only applicable to a motion completion model constructed based on a model (for example, a convolutional neural network) that can accept an input of a two-dimensional image, has a limitation of processing data, and cannot be applied to a motion completion model constructed based on a sequence processing model (for example, a Transformer model).

Based on this, an embodiment of this application further provides a method for training a motion completion model, which may be used for training a motion completion model constructed based on a sequence processing model (for example, a Transformer model). Specifically, a motion frame is considered as a motion sequence sample, and each motion frame corresponds to a motion frame parameter vector; a single motion frame or a consecutive motion frame segment (namely, the first motion sub-sequence sample) is then randomly determined from the motion sequence sample as a target of subsequent training; and a plurality of masking processing modes are further introduced, to perform masking processing on motion frame parameters of the determined single motion frame or consecutive motion frame segment, so that the motion completion model learns how to restore related motion frame parameters from different noise, to improve a learning capability of the model. Detailed descriptions are provided below.

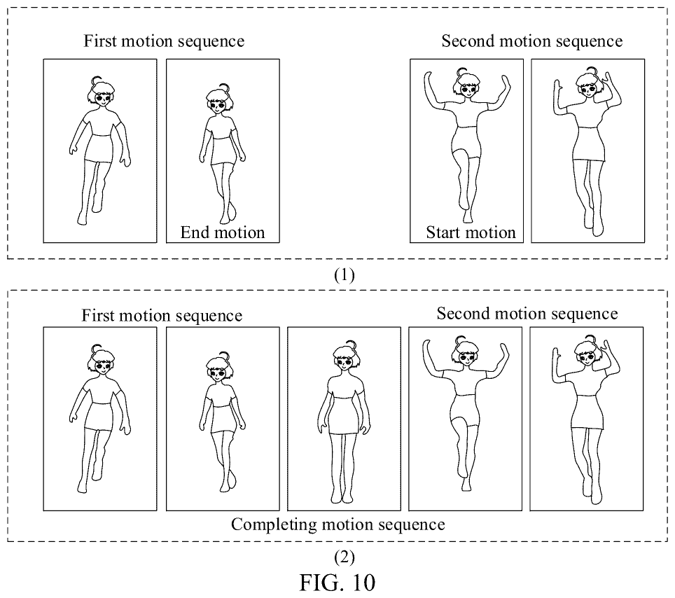

An exemplary application of a motion completion model is first described. FIG. 10 is a schematic diagram of motion completion processing according to an embodiment of this application. An application scenario is connection between motion frames of a digital human. To obtain a longer motion sequence of the digital human, a plurality of different short motion sequences are required to form a longer motion sequence. However, different motion sequences often lack continuity. Therefore, connecting motion frames need to be inserted, to make the entire formed motion sequence look smoother. The motion completion model can be configured for inserting a connecting motion sequence between two motion sequences. In two dance motion sequences are shown in (1) in FIG. 10, a significant difference exists between an end motion frame of the first motion sequence and a start motion frame of the second motion sequence. If the two motion sequences are directly spliced together, there is a significant sense of incontinuity. A completing motion sequence may be obtained through prediction by the motion completion model, and the completing motion sequence is added between the two dance motion sequences shown in (1) in FIG. 10 to connect motion frames, so that an entire motion sequence formed by the two dance motion sequences can look much smoother, as shown in (2) in FIG. 10.

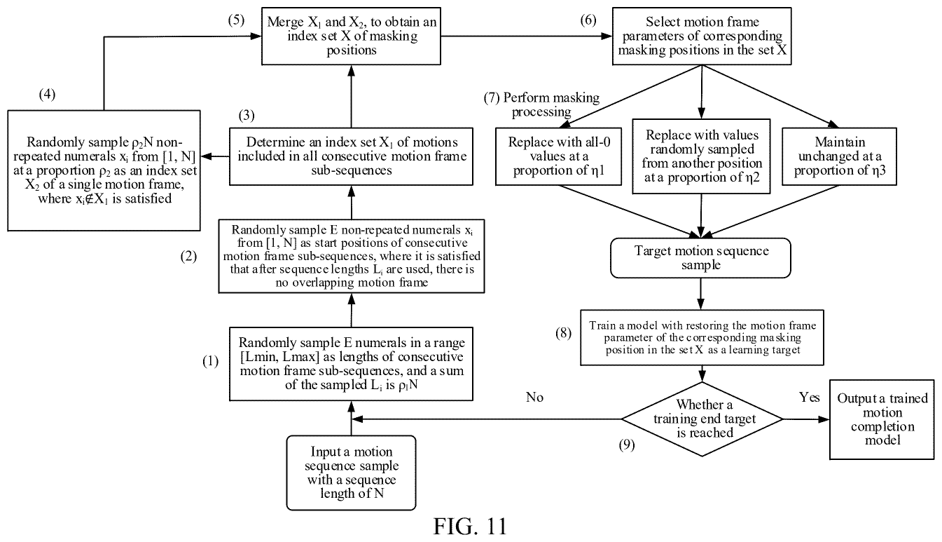

The following describes the method for training a motion completion model provided in the embodiments of this application. FIG. 11 is a schematic flowchart of a method for training a motion completion model according to an embodiment of this application. In this embodiment of this application, a motion sequence sample with a sequence length of N (that is, including N motion frames) is first obtained, and motion sub-sequence samples on which masking processing needs to be performed are then determined from the motion sequence sample. A learning objective of the motion completion model is: after masking processing is performed on original motion frame parameters of the motion sub-sequence samples, restoring the motion frame parameters. The entire training process is repeated several times until a training stop standard is reached. In an actual application, a plurality of motion sequence samples participate in training. A process of training the motion completion model based on one motion sequence sample is merely exemplarily described herein. When training is based on a plurality of motion sequence samples, the method for training a motion completion model provided in the embodiments of this application is applied to the plurality of motion sequence samples in parallel.

Details of each operation shown in FIG. 11 are described below. The sequence length of the motion sequence sample is N. In other words, a total of N different motion frames are included. There are two masking types (namely, types of the first motion sub-sequence sample), that is, a consecutive motion frame sub-sequence (namely, the second-type motion sub-sequence sample) and a single motion frame (namely, the first-type motion sub-sequence sample). Motion frame proportions corresponding to the consecutive motion frame sub-sequence and the single motion frame are respectively ρ₁ and ρ₂.

1. Determine the consecutive motion frame sub-sequence (a masking position of consecutive motion frames). This corresponds to operations (1), (2), and (3) shown in FIG. 11. For the consecutive motion frame sub-sequence, ρ₁N motion frames in total need to be selected from the motion sequence sample for masking processing, and the consecutive motion frame sub-sequences have no overlapping motion frame with each other.

Therefore, in operation (1), E numerals in a range [Lₘᵢₙ, Lₘₐₓ] are randomly sampled as lengths Lᵢ of the consecutive motion frame sub-sequence, and a sum of Lᵢ satisfying sampling is ρ₁N. A sequence length of each consecutive motion frame sub-sequence needs to be first determined. Specifically, a smallest sequence length and a largest sequence length of the consecutive motion frame sub-sequence are set to be respectively Lₘᵢₙ and Lₘₐₓ. In this way, E (where E is variable) values Lᵢ may be randomly sampled from a sequence length range [Lₘᵢₙ, Lₘₐₓ] as lengths of E sub-sequences, and a sum of E sub-sequence lengths is ρ₁N, that is, Σᵢ₌₁^{M}Lᵢ=ρ₁N. Distribution of random sampling may be uniform distribution, normal distribution, or the like.

In operation (2), E non-repeated numerals xᵢ are randomly sampled from a range[1, N] as start positions of the consecutive motion frame sub-sequences, and it is satisfied that after the sequence lengths Lᵢ are used, there is no overlapping motion frame. A motion frame corresponding to each consecutive motion frame sub-sequence is determined. To be specific, a starting motion frame of the consecutive motion frame sub-sequence is determined in a case that a sub-sequence length is known. Similarly, E different numerals xᵢ are randomly sampled from the range [1, N], a motion frame corresponding to the numeral xᵢ is used as a start point of the consecutive motion frame sub-sequence, Lᵢ is used as the sequence length of the consecutive motion frame sub-sequence, so that there is no overlapping motion frame between the determined consecutive motion frame sub-sequences. That is, for xᵢ and Lᵢ, ∀(xⱼ,Lⱼ) satisfies xⱼ+Lⱼ≤xᵢ or xⱼ≥xᵢ+Lᵢ. xⱼ is a start point of another consecutive motion frame sub-sequence (namely, the second motion sub-sequence sample) adjacent to the consecutive motion frame sub-sequence with xᵢ as the start point, and Lⱼ is a sequence length of the another consecutive motion frame sub-sequence (namely, the second motion sub-sequence sample) adjacent to the consecutive motion frame sub-sequence with xᵢ as the start point.

In operation (3), an index set X₁ of motion frames included in all consecutive motion frame sub-sequences (namely, an index set of masking positions of the consecutive motion frame sub-sequences) is determined. Based on a determined set of the plurality of consecutive motion frame sub-sequences {(xᵢ, Lᵢ)}, an index of a consecutive motion frame sub-sequence that needs masking processing is obtained. In other words, for any (xᵢ, Lᵢ), all positive integers in a range[xᵢ, Lᵢ) are placed into the index set X₁ as the indexes of the consecutive motion frame sub-sequences and. That is, X₁={x|xε [symbol] , ∃(xᵢ, Lᵢ) enables xᵢ≤x≤xᵢ+Lᵢ}.

2. Determine the single motion frame (a masking position of the single motion frame). This corresponds to operation (4) shown in FIG. 11. In operation (4), ρ₂N non-repeated numerals xᵢ are randomly sampled from [1, N] at a proportion of ρ₂ as an index set X₂ of the single motion frame (namely, an index set of the masking position of the single motion frame), and satisfies xᵢ ∉X₁. ρ₂N different values xᵢ are randomly sampled from the range [1, N], and xᵢ satisfies xᵢ∃X₁. A selected xᵢ is placed into the index set X₂. Determined single motion frames are inconsecutive and do not overlap the consecutive motion frame sub-sequence. The determining of the single motion frame is configured for introducing a new noise form, to enrich a learning objective.

3. Perform masking processing on motion frame parameters with the determined masking positions. This corresponds to operations (5), (6), and (7) shown in FIG. 11. After the masking positions on which masking processing is to be performed are obtained, noise may be added to these positions, so that the motion completion model learns how to restore original motion frame parameters at the masking positions, to obtain a capability of performing motion completion for gaps between a plurality of motion sequences. Referring to FIG. 8, for the determined masking position (including the masking positions of the consecutive motion frame sub-sequence and the single motion frame), masking processing is performed in three types of masking processing modes, that is, the motion frame parameter at the masking position is randomly filled with three types of values (including all-0 values, randomly sampling values, and maintaining original values). The motion completion model needs to attempt to restore, at the masking position, the original motion frame parameter before filling, to obtain the predicted motion frame parameter, and the value of the loss function of the motion completion model is calculated based on a difference between the predicted motion frame parameter and an original motion frame parameter, so that the model parameter of the motion completion model is updated based on the value of the loss function, to train the motion completion model. The following describes operations (5), (6), and (7) shown in FIG. 11.

In operation (5), X₁ and X₂ are merged, to obtain an index set X of the masking positions. The obtained index sets X₁ and X₂ are merged, to obtain the new index set X of positions. That is X=X₁∪X₂, where X includes (ρ₁+ρ₂)N indexes.

In operation (6), motion frame parameters of corresponding masking positions are selected from the index set X. The motion frame parameters corresponding to the positions are selected from the motion sequence sample based on a position index in X.

In operation (7), masking processing is performed. The motion frame parameters obtained in operation (6) are randomly replaced with three different noise parameters at a corresponding masking portion, so that the motion completion model learns, from noise, a capability of restoring the original motion frame parameter. For example, (1) the motion frame parameters are replaced with all-0 parameters at a masking proportion of η₁, and to be specific, η₁|X| motion frame parameter vectors in X are to be placed with the all-0 parameters; (2) the motion frame parameters are replaced with random parameters at a masking proportion of η₂, and to be specific, η₂|X| motion frame parameter vectors in X are to be replaced with a motion frame parameter vector of a motion frame randomly sampled from the motion sequence sample (where it needs to be ensured that a motion frame parameter vector of a current position is not to be randomly sampled); and (3) existing motion frame parameters are unchanged at a masking proportion of η₃, and to be specific, η₃|X| motion frame parameter vectors in X are to remain unchanged, however, in final calculation of the loss function, a prediction result at a current position is still to be included in calculation.

4. Train the motion completion model by using the target motion sequence sample including noise after the masking processing. This corresponds to operations (8) and (9) shown in FIG. 11. In operation (8), the model is trained with restoring the motion frame parameter of the corresponding masking position in the set X as a learning target. As shown in FIG. 8, the motion completion model receives, as an input, the target motion sequence sample obtained after the masking position is replaced and filled, and then outputs the predicted motion frame parameter corresponding to the masking position. A loss function is calculated between the predicted motion frame parameters of the masking positions and original motion frame parameters of corresponding positions, and a corresponding error is back-propagated to the motion completion model for training. The loss function herein may be an absolute value error function, a square root error function, or the like, which is not limited in the embodiments of this application. The motion completion model herein may be a sequence processing model, for example, a Transformer model.

In operation (9), whether a training end target is reached is determined. During each round of training, whether training of the motion completion model reaches the training end target is determined. The training end target may be that an indicator, for example, a loss or accuracy of the motion completion model on a verification set, reaches a specific value, or may be that the motion completion model has been trained for a specified quantity of steps/epochs. If the training end target is reached, a trained motion completion model is outputted; or if the training end target is not reached, the foregoing operations continue to be repeated to train the motion completion model until the training end target is reached. In this way, the trained motion completion model is obtained.

In some other embodiments, (1) a consecutive motion frame sub-sequence may be first randomly selected for training once, and a single motion frame may be then selected for training once, to obtain the trained motion completion model, which may be performed in a reverse sequence in an actual application. (2) Training may alternatively be performed by using any masking type only. (3) Randomly selected masking positions may not overlap each other, or an overlapping masking position may be selected, and only a union of indexes of all selected masking positions is kept during training. (4) When masking processing is performed on the motion frame parameter at the masking position, any one or more of the above three masking processing modes may be selectively used as required.

Based on the foregoing embodiments of this application, more masking types (such as masking of a consecutive motion frame sub-sequence and masking of a single motion frame) and more types of masking processing modes (all-0 values, randomly sampling values, and maintaining original values) are introduced, richer samples are obtained to train the motion completion model, so that the motion completion model can obtain more knowledge to achieve better performance. In the embodiments of this application, motion completion processing is further performed on Archive of Motion Capture as Surface Shapes (AMASS) by respectively using the motion completion model obtained through training in the embodiments of this application and the linear interpolation manner in the related art, to obtain a completing motion sequence. Indicators of mean per joint position errors (MPJPE) for the predicted completing motion sequence and an original motion frame at spatial positions are shown in Table 1 below. An error of the motion completion model obtained through training in the embodiments of this application is less than an error of the linear interpolation manner. In other words, the motion completion model obtained through training in the embodiments of this application has higher motion completion precision and a better effect.

TABLE 1

| Motion completion processing manner | MPJPE |
|---|---|
| Linear interpolation manner | 97.483 mm |
| Embodiments of this application | 62.956 mm |

The following continues to describe an exemplary structure of the apparatus 555 for training a motion completion model provided in the embodiments of this application implemented as a software module. In some embodiments, as shown in FIG. 2, the software module in the apparatus 555 for training a motion completion model stored in the memory 550 may include: the obtaining module 5551, configured to obtain a motion sequence sample, the motion sequence sample including at least three consecutive motion frames; the determining module 5552, configured to determine at least one first motion sub-sequence sample from the motion sequence sample, the first motion sub-sequence sample having two second motion sub-sequence samples adjacent thereto, and the first motion sub-sequence sample and the second motion sub-sequence samples each including at least one of the motion frames; the masking module 5553, configured to perform masking processing on the at least one first motion sub-sequence sample, to obtain a target motion sequence sample; the motion completion module 5554, configured to perform motion completion processing on the target motion sequence sample through the motion completion model, to obtain a completing motion sequence; and the updating module 5555, configured to update a model parameter of the motion completion model based on a difference between the completing motion sequence and the at least one first motion sub-sequence sample, to obtain a trained motion completion model. The trained motion completion model is configured to perform motion completion processing on at least two motion sequences, to obtain a target motion sequence, motion frames of the at least two motion sequences are inconsecutive, and the target motion sequence is configured to cause the motion frames of the at least two motion sequences to be consecutive.

In some embodiments, the determining module 5552 is further configured to: obtain a sequence length range for determining the first motion sub-sequence sample and a total sequence length of the at least one first motion sub-sequence sample, the total sequence length being less than a motion sequence length of the motion sequence sample; select at least one sub-sequence length in the sequence length range, a sum of the at least one sub-sequence length being equal to the total sequence length; and determine, for each of the at least one sub-sequence length, a first motion sub-sequence sample having the sub-sequence length from the motion sequence sample.

In some embodiments, the determining module 5552 is further configured to: determine at least one target motion frame from the motion sequence sample, each of the at least one target motion frame being corresponding to one of the at least one sub-sequence length; and respectively perform the following processing for each target motion frame: determining a motion frame quantity corresponding to the sub-sequence length corresponding to the target motion frame; and determining, by using the target motion frame in the motion sequence sample as a starting motion frame, consecutive first motion frames corresponding to the motion frame quantity, and determining the first motion frames corresponding to the motion frame quantity as the first motion sub-sequence sample.

In some embodiments, each motion frame in the motion sequence sample has a corresponding motion frame serial number, and the determining module 5552 is further configured to select at least one target motion frame serial number from motion frame serial numbers of the motion frames in the motion sequence sample, a quantity of the at least one target motion frame serial number being the same as a quantity of the at least one sub-sequence length; and determine a motion frame having the at least one target motion frame serial number from the motion sequence sample as the at least one target motion frame.

In some embodiments, the at least one first motion sub-sequence sample includes at least one of the following types of motion sub-sequence samples: a first-type motion sub-sequence sample or a second-type motion sub-sequence sample. The first-type motion sub-sequence sample includes one motion frame, and the second-type motion sub-sequence sample includes at least two consecutive motion frames. When the at least one first motion sub-sequence sample includes a plurality of first-type motion sub-sequence samples, motion frames included in the first-type motion sub-sequence samples are inconsecutive.

In some embodiments, a plurality of first motion sub-sequence samples are provided, and the plurality of first motion sub-sequence samples include the first-type motion sub-sequence sample and the second-type motion sub-sequence sample; and the determining module 5552 is further configured to: obtain a first motion frame quantity corresponding to the first-type motion sub-sequence sample and a second motion frame quantity corresponding to the second-type motion sub-sequence sample; determine at least one first-type motion sub-sequence sample from the motion sequence sample, a total quantity of motion frames included in the at least one first-type motion sub-sequence sample being the first motion frame quantity; and determine at least one second-type motion sub-sequence sample from the motion sequence sample, a total quantity of motion frames included in the at least one second-type motion sub-sequence sample being the second motion frame quantity.

In some embodiments, the determining module 5552 is further configured to: obtain a first motion frame proportion corresponding to the first-type motion sub-sequence sample and a second motion frame proportion corresponding to the second-type motion sub-sequence sample; obtain a total motion frame quantity of the motion frames included in the motion sequence sample; multiply the first motion frame proportion by the total motion frame quantity, to obtain the first motion frame quantity; and multiply the second motion frame proportion by the total motion frame quantity, to obtain the second motion frame quantity.

In some embodiments, the motion sequence sample includes: motion frame parameters of the motion frames in the motion sequence sample; and the masking module 5553 is further configured to: determine, from the motion frame parameters of the motion frames in the motion sequence sample, a target motion frame parameter of a motion frame included in the at least one first motion sub-sequence sample; and perform masking processing on the target motion frame parameter, to obtain the target motion sequence sample.

In some embodiments, the masking module 5553 is further configured to: obtain a masking processing mode configured for the masking processing; and perform masking processing on the target motion frame parameter in the masking processing mode, to obtain the target motion sequence sample. The masking processing mode includes at least one of the following: setting the target motion frame parameter to a target value, setting the target motion frame parameter to a random value, or maintaining the target motion frame parameter unchanged.

In some embodiments, the at least one first motion sub-sequence sample includes a plurality of motion frames, and a plurality of target motion frame parameters are provided; and when a plurality of masking processing modes are provided, the masking module 5553 is further configured to: obtain a masking processing proportion of each of the masking processing modes; determine a to-be-masked motion frame parameter corresponding to each of the masking processing modes from the plurality of target motion frame parameters based on each masking processing proportion; and perform masking processing on the to-be-masked motion frame parameter corresponding to each of the masking processing modes by using the masking processing mode, to obtain the target motion sequence sample.

In some embodiments, the motion completion module 5554 is further configured to predict, through the motion completion model, the masked target motion frame parameter in the target motion sequence sample, to obtain a predicted motion frame parameter, and determine the predicted motion frame parameter as the completing motion sequence; and the updating module 5555 is further configured to: determine a value of a loss function of the motion completion model based on a difference between the predicted motion frame parameter and the target motion frame parameter; and update the model parameter of the motion completion model based on the value of the loss function.

In some embodiments, the motion completion model includes an input feature conversion layer, a motion completion layer, and an output feature conversion layer; and the motion completion module 5554 is further configured to: perform feature conversion on the target motion sequence sample through the input feature conversion layer, to obtain a motion sequence conversion feature; perform motion completion processing on the motion sequence conversion feature through the motion completion layer, to obtain a completing motion sequence feature; and perform feature conversion on the completing motion sequence feature through the output feature conversion layer, to obtain the completing motion sequence.

In some embodiments, the motion completion layer includes M cascaded motion completion sub-layers, and the motion completion module 5554 is further configured to: perform motion completion processing on the motion sequence conversion feature through a 1^{st} motion completion sub-layer in the M cascaded motion completion sub-layers, to obtain an intermediate completing motion sequence feature of the 1^{st} motion completion sub-layer; perform motion completion processing on an intermediate completing motion sequence feature of an (n−1)^{th} motion completion sub-layer through an n^{th} motion completion sub-layer in the M cascaded motion completion sub-layers, to obtain an intermediate completing motion sequence feature of the n^{th} motion completion sub-layer, M and n being integers greater than 1, and n being less than or equal to M; and traverse the n intermediate completing motion sequence features to obtain an intermediate completing motion sequence feature of an M^{th} motion completion sub-layer, and determine the intermediate completing motion sequence feature of the M^{th} motion completion sub-layer as the completing motion sequence feature.

According to the embodiments of this application, at least one first motion sub-sequence sample is first determined from a motion sequence sample including at least three consecutive motion frames. The first motion sub-sequence sample has two second motion sub-sequence samples adjacent thereto. Masking processing is performed on the at least one first motion sub-sequence sample in the motion sequence sample, to obtain a target motion sequence sample. Motion completion processing is then performed on the target motion sequence sample through a motion completion model, to obtain a completing motion sequence, so that a model parameter of the motion completion model is updated based on a difference between the completing motion sequence and the at least one first motion sub-sequence sample that is masked, to train the motion completion model. In this way, a trained motion completion model is obtained.

Through the trained motion completion model, motion completion processing can be performed on at least two motion sequences in which motion frames of the motion sequences are inconsecutive, to obtain a target motion sequence. The target motion sequence enables the motion frames of the at least two motion sequences to be consecutive. In this way, when motion completion processing is performed on a motion sequence of an object (for example, a digital human or a virtual human) through the trained motion completion model, precision of the motion completion processing can be improved, and motion completion processing of two or more motion sequences in which motion frames are inconsecutive between the motion sequences can be implemented, thereby improving efficiency of the motion completion processing.

An embodiment of this application further provides a motion completion apparatus. The motion completion apparatus includes: a motion sequence obtaining module, configured to obtain at least two motion sequences on which motion completion is to be performed, motion frames of the at least two motion sequences being inconsecutive; an invoking module, configured to perform motion completion processing on the at least two motion sequences by invoking a motion completion model, to obtain a target motion sequence, the target motion sequence being configured to cause the motion frames of the at least two motion sequences to be consecutive; and a combining module, configured to combine the target motion sequence and the at least two motion sequences, to obtain a target completed motion sequence of the at least two motion sequences. The motion completion model is obtained through training based on the method for training a motion completion model provided in the embodiments of this application.

According to the embodiments of this application, through the trained motion completion model, motion completion processing can be performed on at least two motion sequences in which motion frames are inconsecutive between motion sequences, to obtain a target motion sequence, where the target motion sequence enables the motion frames of the at least two motion sequences to be consecutive. In this way, when motion completion processing is performed on a motion sequence of an object (for example, a digital human or a virtual human) through the trained motion completion model, precision of the motion completion processing can be improved, and motion completion processing of two or more motion sequences in which motion frames are inconsecutive between the motion sequences can be implemented, thereby improving efficiency of the motion completion processing.

An embodiment of this application further provides a computer program product. The computer program product includes computer-executable instructions or a computer program. The computer-executable instructions or the computer program is stored in a computer-readable storage medium. A processor of an electronic device reads the computer-executable instructions or the computer program from the computer-readable storage medium, and the processor executes the computer-executable instructions or the computer program, to enable the electronic device to perform the method provided in the embodiments of this application.

An embodiment of this application further provides a computer-readable storage medium having computer-executable instructions or a computer program stored therein. When the computer-executable instructions or the computer program is executed by a processor, the processor is caused to perform the method provided in the embodiments of this application.

In some embodiments, the computer-readable storage medium may be a memory such as a RAM, a ROM, a flash memory, a magnetic surface memory, an optical disc, or a CD-ROM; or may be various devices including one or any combination of the foregoing memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or as a module, a component, a subroutine, or another unit suitable for use in a computing environment.

For example, the computer-executable instructions may, but do not necessarily, correspond to a file in a file system, and may be stored in a part of a file that stores other programs or data, for example, stored in one or more scripts in a hypertext markup language (HTML) file, stored in a single file dedicated to a discussed program, or stored in a plurality of collaborative files (for example, files that store one or more modules, subprograms, or code parts).

For example, the computer-executable instructions may be deployed to be executed on one electronic device, or on a plurality of electronic devices located at one location, or on a plurality of electronic devices distributed at a plurality of locations and interconnected through a communication network.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely embodiments of this application and are not intended to limit the protection scope of this application. Any modification, equivalent replacement, or improvement made without departing from the spirit and scope of this application shall fall within the protection scope of this application.

What is claimed is:

1. A method for training a motion completion model performed by an electronic device, the method comprising:
determining at least one first motion sub-sequence sample from a motion sequence sample, the first motion sub-sequence sample having two second motion sub-sequence samples adjacent thereto, and the first motion sub-sequence sample and the two second motion sub-sequence samples each comprising at least one motion frame from the motion sequence sample;
performing masking processing on the at least one first motion sub-sequence sample, to obtain a target motion sequence sample;
performing motion completion processing on the target motion sequence sample through the motion completion model, to obtain a completing motion sequence; and
updating a model parameter of the motion completion model based on a difference between the completing motion sequence and the at least one first motion sub-sequence sample, to obtain a trained motion completion model.

2. The method according to claim 1, wherein the determining at least one first motion sub-sequence sample from the motion sequence sample comprises:
obtaining a sequence length range for determining the first motion sub-sequence sample and a total sequence length of the at least one first motion sub-sequence sample, the total sequence length being less than a motion sequence length of the motion sequence sample;
selecting at least one sub-sequence length in the sequence length range, a sum of the at least one sub-sequence length being equal to the total sequence length; and
determining, for each of the at least one sub-sequence length, a first motion sub-sequence sample having the sub-sequence length from the motion sequence sample.

3. The method according to claim 2, wherein the determining, for each of the at least one sub-sequence length, a first motion sequence sample having the sub-sequence length from the motion sequence sample comprises:
determining at least one target motion frame from the motion sequence sample, each of the at least one target motion frame being corresponding to one of the at least one sub-sequence length; and
respectively performing the following processing for each of the at least one target motion frame:
determining a motion frame quantity corresponding to the sub-sequence length corresponding to the target motion frame; and
determining, by using the target motion frame in the motion sequence sample as a starting motion frame, consecutive first motion frames corresponding to the motion frame quantity, and determining the first motion frames corresponding to the motion frame quantity as the first motion sub-sequence sample.

4. The method according to claim 3, wherein each motion frame in the motion sequence sample has a motion frame serial number, and the determining at least one target motion frame from the motion sequence sample comprises:
selecting at least one target motion frame serial number from the motion frame serial numbers of the motion frames in the motion sequence sample, a quantity of the at least one target motion frame serial number being the same as a quantity of the at least one sub-sequence length; and
determining a motion frame having the at least one target motion frame serial number from the motion sequence sample as the at least one target motion frame.

5. The method according to claim 1, wherein the at least one first motion sub-sequence sample comprises at least one of the following types of motion sub-sequence samples:
a first-type motion sub-sequence sample or a second-type motion sub-sequence sample,
the first-type motion sub-sequence sample comprising one motion frame, and the second-type motion sub-sequence sample comprising at least two consecutive motion frames,
when the at least one first motion sub-sequence sample comprises a plurality of first-type motion sub-sequence samples, motion frames comprised in the first-type motion sub-sequence samples are inconsecutive.

6. The method according to claim 5, wherein a plurality of first motion sub-sequence samples are provided, and the plurality of first motion sub-sequence samples comprise the first-type motion sub-sequence sample and the second-type motion sub-sequence sample; and
the determining at least one first motion sub-sequence sample from the motion sequence sample comprises:
obtaining a first motion frame quantity corresponding to the first-type motion sub-sequence sample and a second motion frame quantity corresponding to the second-type motion sub-sequence sample;
determining at least one first-type motion sub-sequence sample from the motion sequence sample, a total quantity of motion frames comprised in the at least one first-type motion sub-sequence sample being the first motion frame quantity; and
determining at least one second-type motion sub-sequence sample from the motion sequence sample, a total quantity of motion frames comprised in the at least one second-type motion sub-sequence sample being the second motion frame quantity.

7. The method according to claim 6, wherein the obtaining a first motion frame quantity corresponding to the first-type motion sub-sequence sample and a second motion frame quantity corresponding to the second-type motion sub-sequence sample comprises:
obtaining a first motion frame proportion corresponding to the first-type motion sub-sequence sample and a second motion frame proportion corresponding to the second-type motion sub-sequence sample;
obtaining a total motion frame quantity of the motion frames comprised in the motion sequence sample;
multiplying the first motion frame proportion by the total motion frame quantity, to obtain the first motion frame quantity; and
multiplying the second motion frame proportion by the total motion frame quantity, to obtain the second motion frame quantity.

8. The method according to claim 1, wherein the motion sequence sample comprises: motion frame parameters of motion frames in the motion sequence sample; and the performing masking processing on the at least one first motion sub-sequence sample, to obtain a target motion sequence sample comprises:
determining, from the motion frame parameters of the motion frames in the motion sequence sample, a target motion frame parameter of a motion frame comprised in the at least one first motion sub-sequence sample; and
performing masking processing on the target motion frame parameter, to obtain the target motion sequence sample.

9. The method according to claim 8, wherein the performing masking processing on the target motion frame parameter, to obtain the target motion sequence sample comprises:
obtaining a masking processing mode configured for the masking processing; and
performing masking processing on the target motion frame parameter in the masking processing mode, to obtain the target motion sequence sample,
the masking processing mode comprising at least one of the following:
setting the target motion frame parameter to a target value, setting the target motion frame parameter to a random value, or maintaining the target motion frame parameter unchanged.

10. The method according to claim 9, wherein the at least one first motion sub-sequence sample comprises a plurality of motion frames, and a plurality of target motion frame parameters are provided; and
when a plurality of masking processing modes are provided, the performing masking processing on the target motion frame parameter in the masking processing mode, to obtain the target motion sequence sample comprises:
obtaining a masking processing proportion of each of the masking processing modes;
determining a to-be-masked motion frame parameter corresponding to each of the masking processing modes from the plurality of target motion frame parameters based on each masking processing proportion; and
performing masking processing on the to-be-masked motion frame parameter corresponding to each of the masking processing modes by using the masking processing mode, to obtain the target motion sequence sample.

11. The method according to claim 8, wherein the performing motion completion processing on the target motion sequence sample through the motion completion model, to obtain a completing motion sequence comprises:
predicting, through the motion completion model, the masked target motion frame parameter in the target motion sequence sample, to obtain a predicted motion frame parameter, and determining the predicted motion frame parameter as the completing motion sequence; and
the updating a model parameter of the motion completion model based on a difference between the completing motion sequence and the at least one first motion sub-sequence sample comprises:
determining a value of a loss function of the motion completion model based on a difference between the predicted motion frame parameter and the target motion frame parameter; and
updating the model parameter of the motion completion model based on the value of the loss function.

12. The method according to claim 1, wherein the motion completion model comprises an input feature conversion layer, a motion completion layer, and an output feature conversion layer; and
the performing motion completion processing on the target motion sequence sample through the motion completion model, to obtain a completing motion sequence comprises:
performing feature conversion on the target motion sequence sample through the input feature conversion layer, to obtain a motion sequence conversion feature;
performing motion completion processing on the motion sequence conversion feature through the motion completion layer, to obtain a completing motion sequence feature; and
performing feature conversion on the completing motion sequence feature through the output feature conversion layer, to obtain the completing motion sequence.

13. The method according to claim 12, wherein the motion completion layer comprises M cascaded motion completion sub-layers, and the performing motion completion processing on the motion sequence conversion feature through the motion completion layer, to obtain a completing motion sequence feature comprises:
performing motion completion processing on the motion sequence conversion feature through a 1^{st} motion completion sub-layer in the M cascaded motion completion sub-layers, to obtain an intermediate completing motion sequence feature of the 1^{st} motion completion sub-layer;
performing motion completion processing on an intermediate completing motion sequence feature of an (n−1)^{th} motion completion sub-layer through an n^{th} motion completion sub-layer in the M cascaded motion completion sub-layers, to obtain an intermediate completing motion sequence feature of the n^{th} motion completion sub-layer,
M and n being integers greater than 1, and n being less than or equal to M; and
traversing the n intermediate completing motion sequence features to obtain an intermediate completing motion sequence feature of an M^{th} motion completion sub-layer, and determining the intermediate completing motion sequence feature of the M^{th} motion completion sub-layer as the completing motion sequence feature.

14. The method according to claim 1, wherein the motion sequence sample comprises at least three consecutive motion frames.

15. An electronic device, comprising:
a memory, configured to store computer-executable instructions; and
a processor, configured to implement, when executing the computer-executable instructions stored in the memory, a method for training a motion completion model including:
determining at least one first motion sub-sequence sample from a motion sequence sample, the first motion sub-sequence sample having two second motion sub-sequence samples adjacent thereto, and the first motion sub-sequence sample and the two second motion sub-sequence samples each comprising at least one motion frame from the motion sequence sample;
performing masking processing on the at least one first motion sub-sequence sample, to obtain a target motion sequence sample;
performing motion completion processing on the target motion sequence sample through the motion completion model, to obtain a completing motion sequence; and
updating a model parameter of the motion completion model based on a difference between the completing motion sequence and the at least one first motion sub-sequence sample, to obtain a trained motion completion model.

16. The electronic device according to claim 15, wherein the determining at least one first motion sub-sequence sample from the motion sequence sample comprises:
obtaining a sequence length range for determining the first motion sub-sequence sample and a total sequence length of the at least one first motion sub-sequence sample, the total sequence length being less than a motion sequence length of the motion sequence sample;
selecting at least one sub-sequence length in the sequence length range, a sum of the at least one sub-sequence length being equal to the total sequence length; and
determining, for each of the at least one sub-sequence length, a first motion sub-sequence sample having the sub-sequence length from the motion sequence sample.

17. The electronic device according to claim 15, wherein the at least one first motion sub-sequence sample comprises at least one of the following types of motion sub-sequence samples:
a first-type motion sub-sequence sample or a second-type motion sub-sequence sample,
the first-type motion sub-sequence sample comprising one motion frame, and the second-type motion sub-sequence sample comprising at least two consecutive motion frames,
when the at least one first motion sub-sequence sample comprises a plurality of first-type motion sub-sequence samples, motion frames comprised in the first-type motion sub-sequence samples are inconsecutive.

18. The electronic device according to claim 15, wherein the motion sequence sample comprises: motion frame parameters of motion frames in the motion sequence sample; and the performing masking processing on the at least one first motion sub-sequence sample, to obtain a target motion sequence sample comprises:
determining, from the motion frame parameters of the motion frames in the motion sequence sample, a target motion frame parameter of a motion frame comprised in the at least one first motion sub-sequence sample; and
performing masking processing on the target motion frame parameter, to obtain the target motion sequence sample.

19. The electronic device according to claim 15, wherein the motion completion model comprises an input feature conversion layer, a motion completion layer, and an output feature conversion layer; and
the performing motion completion processing on the target motion sequence sample through the motion completion model, to obtain a completing motion sequence comprises:
performing feature conversion on the target motion sequence sample through the input feature conversion layer, to obtain a motion sequence conversion feature;
performing motion completion processing on the motion sequence conversion feature through the motion completion layer, to obtain a completing motion sequence feature; and
performing feature conversion on the completing motion sequence feature through the output feature conversion layer, to obtain the completing motion sequence.

20. A non-transitory computer-readable storage medium, having computer-executable instructions stored therein, the computer-executable instructions, when executed by a processor of an electronic device, causing the electronic device to implement a method for training a motion completion model including:
determining at least one first motion sub-sequence sample from a motion sequence sample, the first motion sub-sequence sample having two second motion sub-sequence samples adjacent thereto, and the first motion sub-sequence sample and the two second motion sub-sequence samples each comprising at least one motion frame from the motion sequence sample;
performing masking processing on the at least one first motion sub-sequence sample, to obtain a target motion sequence sample;
performing motion completion processing on the target motion sequence sample through the motion completion model, to obtain a completing motion sequence; and
updating a model parameter of the motion completion model based on a difference between the completing motion sequence and the at least one first motion sub-sequence sample, to obtain a trained motion completion model.
